(19) United States
(12) Patent Application Publication
(10) Pub. No.: US 2010/0110368 A1
(43) Pub. Date: May 6, 2010

(54) SYSTEM AND APPARATUS FOR EYEGLASS APPLIANCE PLATFORM

(76) Inventor: David Chaum, Sherman Oaks, CA (US)

Correspondence Address: CHRISTIE, PARKER & HALE, LLP, PO BOX 7068, PASADENA, CA, 91109-7068, US

(21) Appl. No.: 12/575,421

(22) Filed: Oct. 7, 2009

Related U.S. Application Data
(63) Continuation-in-part of application No. PCT/US2009/002174, filed on Apr. 6, 2009.
Application No. PCT/US2009/002174 is a continuation-in-part of application No. PCT/US2009/002182, filed on Apr. 6, 2009.
(60) Provisional application No. 61/110,591, filed on Nov. 2, 2008.
(60) Provisional application No. 61/142,347, filed on Jan. 3, 2009.
(60) Provisional application No. 61/169,708, filed on Apr. 15, 2009.
(60) Provisional application No. 61/171,168, filed on Apr. 21, 2009.
(60) Provisional application No. 61/173,700, filed on Apr. 29, 2009.
(60) Provisional application No. 61/180,101, filed on May 20, 2009.
(60) Provisional application No. 61/180,982, filed on May 26, 2009.
(60) Provisional application No. 61/230,744, filed on Aug. 3, 2009.
(60) Provisional application No. 61/232,426, filed on Aug. 8, 2009.

(51) Int. Cl. G02C 11/00; G06F 3/01

(52) U.S. Cl. 351/158; 715/702

(57) ABSTRACT

The present invention relates to a personal multimedia electronic device, and more particularly to a head-worn device such as an eyeglass frame having a plurality of interactive electrical/optical components. In one embodiment, a personal multimedia electronic device includes an eyeglass frame having a side arm and an optic frame; an output device for delivering an output to the wearer; an input device for obtaining an input; and a processor comprising a set of programming instructions for controlling the input device and the output device. The output device is supported by the eyeglass frame and is selected from the group consisting of a speaker, a bone conduction transmitter, an image projector, and a tactile actuator. The input device is supported by the eyeglass frame and is selected from the group consisting of an audio sensor, a tactile sensor, a bone conduction sensor, an image sensor, a body sensor, an environmental sensor, a global positioning system receiver, and an eye tracker. In one embodiment, the processor applies a user interface logic that determines a state of the eyeglass device and determines the output in response to the input and the state.

### CROSS-REFERENCE TO RELATED APPLICATION(S)

This application is a continuation-in-part of PCT Application Nos. PCT/US2009/002174, entitled “Proximal Image Projection System,” filed Apr. 6, 2009 and PCT/US2009/002182, entitled “Proximal Image Projection System,” filed Apr. 6, 2009, the entire contents of which are incorporated by reference herein.

This application claims priority to and the benefit of U.S. Provisional Application Nos. 61/042,762, entitled “Proximal-Screen Image Construction,” filed Apr. 6, 2008; 61/042,764, entitled “Eyeglasses Enhancements,” filed Apr. 6, 2008; 61/042,766, entitled “System for Projecting Images into the Eye,” filed Apr. 6, 2008; 61/045,367, entitled “System for Projecting Images into the Eye,” filed Apr. 16, 2008; 61/050,189, entitled “Light Sourcing for Image Rendering,” filed May 2, 2008; 61/050,602, entitled “Light Sourcing for Image Rendering,” filed May 5, 2008; 61/056,056, entitled “Mirror Array Steering and Front-Optic Mirror Arrangements,” filed May 26, 2008; 61/057,869, entitled “Eyeglasses Enhancements,” filed Jun. 1, 2008; 61/077,340, entitled “Laser-Based Sourcing and Front-Optic,” filed Jul. 1, 2008; 61/110,591, entitled “Foveated Spectacle Projection Without Moving Parts,” filed Nov. 2, 2008; 61/142,347, entitled “Directed Viewing Waveguide Systems,” filed Jan. 3, 2009; 61/169,708, entitled “Holographic Combiner Production Systems,” filed Apr. 15, 2009; 61/171,168, entitled “Proximal Optic Curvature Correction System,” filed Apr. 21, 2009; 61/173,700, entitled “Proximal Optic Structures and Steerable Mirror Based Projection Systems Therefore,” filed Apr. 29, 2009; 61/180,101, entitled “Adjustable Proximal Optic Support,” filed May 20, 2009; 61/180,982, entitled “Projection of Images into the Eye Using Proximal Redirectors,” filed May 26, 2009; 61/230,744, entitled “Soft-Launch-Location and Transmissive Proximal Optic Projection Systems,” filed Aug. 3, 2009; and 61/232,426, entitled “Soft-Launch-Location and Transmissive Proximal Optic Projection Systems,” filed Aug. 8, 2009, the entire contents of all of which are incorporated by reference herein.

### FIELD OF THE INVENTION

The present invention relates to a personal multimedia electronic device, and more particularly to a head-worn device such as an eyeglass frame having a plurality of interactive electrical/optical components.

### BACKGROUND OF THE INVENTION

Portable electronic devices have become increasingly popular among consumers and are now available for a wide variety of applications. Portable electronic devices include cellular phones, MP3 or other music players, cameras, global positioning system (GPS) receivers, laptop computers, personal digital assistants (such as the iPhone, Blackberry, and others), and others. These devices have enabled consumers to access, store, and share electronic information while away from a desktop computer. Consumers are able to send emails and text messages, browse the Internet, take and upload photographs, receive traffic alerts and directions, and other useful applications while away from the home or office. Additionally, consumers have begun to expect and rely on this mobile capability as these portable electronic devices become more available and affordable.

However, the increasing use of these various devices has some disadvantages. First, many people find that they need to carry multiple different devices with them throughout the day in order to have access to all of the applications that they want to use, such as, for example, a compact digital camera, an MP3 player, a cellular phone, and an automotive GPS unit. Each of these different devices has its own operating instructions and operating system, must be properly charged, and may require a particular signal or accessory. Another disadvantage is the distraction of using these devices while driving, as people may drive recklessly when attempting to locate and use one of these devices. Thus, there is still a need for these many different applications and portable electronic devices to be consolidated and made more easy to use.

At the same time that these various applications are being developed and offered to consumers, optical imaging systems are improving, complex optical displays are being developed, and many electrical/optical components such as sensors, processors, and other devices are becoming more capable and more compact. The present invention utilizes these new technologies and creates a new portable electronic device that consolidates and facilitates many of the capabilities of prior devices.

### SUMMARY OF THE INVENTION

The present invention relates to a personal multimedia electronic device, and more particularly to a head-worn device such as an eyeglass frame having a plurality of interactive electrical/optical components. In one embodiment, a personal multimedia electronic device includes an eyeglass frame with electrical/optical components mounted in the eyeglass frame. The electrical/optical components mounted in the eyeglass frame can include input devices such as touch sensors and microphones, which enable the user to input instructions or content to the device. The electrical/optical components can also include output devices such as audio speakers and image projectors, which enable the eyeglass device to display content or provide information to the wearer. The electrical/optical components can also include environmental sensors, such as cameras or other monitors or sensors, and communications devices such as a wireless antenna for transmitting or receiving content (e.g., using Bluetooth) and/or power. Additionally, the electrical/optical components include a computer processor and memory device, which store content and programming instructions. In use, the user inputs instructions to the eyeglass device, such as by touching a touch sensor mounted on the side arm of the eyeglass frame or speaking a command, and the eyeglass device responds with the requested information or content, such as displaying incoming email on the image projector, displaying a map and providing driving instructions via the speaker, taking a photograph with a camera, and/or many other applications.

In one embodiment, a multimedia eyeglass device includes an eyeglass frame having a side arm and an optic frame; an output device for delivering an output to the wearer; an input device for obtaining an input; and a processor comprising a set of programming instructions for controlling the input device and the output device. The output device is supported by the eyeglass frame and is selected from the group consisting of a speaker, a bone conduction transmitter, an image projector, and a tactile actuator. The input device is supported by the eyeglass frame and is selected from the group consisting of an audio sensor, a tactile sensor, a bone conduction sensor, an image sensor, a body sensor, an environmental sensor, a global positioning system receiver, and an eye tracker. In one embodiment, the processor applies a user interface logic that determines a state of the eyeglass device and determines the output in response to the input and the state.

In one embodiment, a head-worn multimedia device includes a frame comprising a side arm and an optic frame; an audio transducer supported by the frame; a tactile sensor supported by the frame; a processor comprising a set of programming instructions for receiving and transmitting information via the audio transducer and the tactile sensor; a memory device for storing such information and instructions; and a power supply electrically coupled to the audio transducer, the tactile sensor, the processor, and the memory device.

In an embodiment, a method for controlling a multimedia eyeglass device includes providing an eyeglass device. The eyeglass device includes an output device for delivering information to the wearer, the output device being selected from the group consisting of a speaker, a bone conduction transmitter, an image projector, and a tactile actuator; an input device for obtaining information, the input device being selected from the group consisting of an audio sensor, a tactile sensor, a bone conduction sensor, an image sensor, a body sensor, an environmental sensor, a global positioning system receiver, and an eye tracker; and a processor comprising a set of programming instructions for controlling the input device and the output device. The method also includes providing an input by the input device; determining a state of the output device, the input device, and the processor; accessing the programming instructions to select a response based on the input and the state; and providing the response by the output device.

### BRIEF DESCRIPTION OF THE DRAWINGS

FIG. 1A is a side elevational view of an electronic eyeglass device according to an embodiment of the invention, in an unfolded position.

FIG. 1B is a side elevational view of a side arm of an eyeglass device according to another embodiment of the invention.

FIG. 1C is a front elevational view of an electronic eyeglass device according to another embodiment of the invention, in an unfolded position.

FIG. 2 is a front view of an electronic eyeglass device according to an embodiment of the invention, in a folded position.

FIG. 3 is a front view of an electronic eyeglass device according to an embodiment of the invention, in a folded position.

FIG. 4 is a front view of an electronic eyeglass device according to an embodiment of the invention, in a folded position.

FIG. 5A is a front view of an electronic eyeglass device according to an embodiment of the invention, in a folded position.

FIG. 5B is a side view of the device of FIG. 5A, in an unfolded position.

FIG. 5C is a top view of the device of FIG. 5A, in an unfolded position.

FIG. 6A is a partial top view of an electronic eyeglass device according to an embodiment of the invention.

FIG. 6B is a partial front view of the device of FIG. 6A.

FIG. 6C is a cross-sectional view of an optic lens according to an embodiment of the invention.

FIG. 6D is a partial front view of an eyeglass device according to another embodiment of the invention.

FIG. 6E is a side view of the eyeglass device of FIG. 6D.

FIG. 6F is a partial top view of the eyeglass device of FIG. 6D.

FIG. 7A is a partial top view of an electronic eyeglass device according to an embodiment of the invention.

FIG. 7B is a partial top view of an electronic eyeglass device according to another embodiment of the invention.

FIG. 7C is a partial top view of an electronic eyeglass device according to another embodiment of the invention.

FIG. 7D is a partial front view of an electronic eyeglass device according to an embodiment of the invention.

FIG. 8A is a partial side view of a side arm of an electronic eyeglass device according to an embodiment of the invention.

FIG. 8B is a schematic view of a coil according to the embodiment of FIG. 8A.

FIG. 8C is a partial side view of the device of FIG. 8A with a boot, according to an embodiment of the invention.

FIG. 8D is a cross-sectional view of the device of FIG. 8C, taken along the line 8D-8D.

FIG. 8E is a front view of an electronic eyeglass device according to an embodiment of the invention.

FIG. 8F is a top view of a storage case according to an embodiment of the invention.

FIG. 8G is a top view of an electronic eyeglass device according to an embodiment of the invention, with a lanyard.

FIG. 8H is a top view of an electronic eyeglass device according to another embodiment of the invention, with a lanyard.

FIG. 9A is a side view of a side arm of an electronic eyeglass device according to an embodiment of the invention.

FIG. 9B is a side view of an electronic eyeglass device with a replacement side arm, according to an embodiment of the invention.

FIG. 9C is a close-up view of a hinge connection according to the embodiment of FIG. 9B.

FIG. 10A is a side view of an attachment unit for an electronic eyeglass device according to an embodiment of the invention.

FIG. 10B is a side view of a traditional eyeglass frame, for use with the attachment unit of FIG. 10A.

FIG. 10C is a side view of an attachment unit according to an embodiment of the invention.

FIG. 10D is a cross-sectional view of a side arm and attachment unit according to an embodiment of the invention.

FIG. 11A is a flow chart of a control system according to an embodiment of the invention.

FIG. 11B is a flow chart of a control system according to another embodiment of the invention.

FIG. 11C is a flow chart of a control system according to another embodiment of the invention.

FIG. 11D is a flow chart of a control system according to another embodiment of the invention.

FIG. 12 is a block diagram of various components according to an exemplary embodiment of the invention.

FIG. 13 is a block diagram of a control system according to an exemplary embodiment of the invention.

FIG. 14A is a block diagram of a dual transducer system according to an embodiment of the invention.

FIG. 14B is a block diagram of a dual transducer system according to an embodiment of the invention.

FIG. 15A is a front view of a folded eyeglass frame according to an embodiment of the invention.

FIG. 15B is a side view of an unfolded eyeglass frame according to an embodiment of the invention.

FIG. 15C is a bottom view of an unfolded eyeglass frame according to an embodiment of the invention.

FIG. 16 is a partial horizontal cross-sectional view of an eyeglass frame with a clamp, according to an embodiment of the invention.

FIG. 17A is a partial side view of an adjustable eyeglass frame according to an embodiment of the invention.

FIG. 17B is a partial side view of an adjustable eyeglass frame according to an embodiment of the invention.

FIG. 17C is a partial side view of an adjustable eyeglass frame according to an embodiment of the invention.

FIG. 17D is a partial horizontal cross-sectional view of an adjustable eyeglass frame according to an embodiment of the invention.

FIG. 18A is a partial vertical cross-sectional view of an adjustable eyeglass frame according to an embodiment of the invention.

FIG. 18B is a partial side view of an adjustable eyeglass frame according to an embodiment of the invention.

FIG. 18C is a partial cross-sectional view of the adjustable eyeglass frame of FIG. 18A taken along line Y-Y.

FIG. 18D is a partial cross-sectional view of the adjustable eyeglass frame of FIG. 18A taken along line Z-Z.

### DETAILED DESCRIPTION OF THE INVENTION

The present invention relates to a personal multimedia electronic device, and more particularly to a head-worn device such as an eyeglass frame having a plurality of interactive electrical/optical components. In one embodiment, a personal multimedia electronic device includes an eyeglass frame with electrical/optical components mounted in the eyeglass frame. The electrical/optical components mounted in the eyeglass frame can include input devices such as touch sensors and microphones, which enable the user to input instructions or content to the device. The electrical/optical components can also include output devices such as audio speakers and image projectors, which enable the eyeglass device to display content or provide information to the wearer. The electrical/optical components can also include environmental sensors, such as cameras or other monitors or sensors, and communications devices such as a wireless antenna for transmitting or receiving content (e.g., using Bluetooth) and/or power. Additionally, the electrical/optical components include a computer processor and memory device, which store content and programming instructions. In use, the user inputs instructions to the eyeglass device, such as by touching a touch sensor mounted on the side arm of the eyeglass frame or speaking a command, and the eyeglass device responds with the requested information or content, such as displaying incoming email on the image projector, displaying a map and providing driving instructions via the speaker, taking a photograph with a camera, and/or many other applications.

This integrated, electronic eyeglass device consolidates many different functionalities into one compact, efficient, and easy to use device. The eyeglass device can be constructed according to different user preferences, so that it includes the electrical/optical components that are necessary for the user's desired applications. Different components such as cameras, projectors, speakers, microphones, temperature sensors, Bluetooth connections, GPS receivers, heart rate monitors, radios, music players, batteries, and other components can be selected as desired to provide applications such as videos, music, email, texting, maps, web browsing, health monitoring, weather updates, phone calls, and others. All of these components and applications can be controlled by the user through touch sensors, audio commands, and other sensors through which the wearer gives instructions to the eyeglass device. The inventor has discovered that this integrated, multi-media head-worn device can be created with advanced optical projections, compact electrical/optical components, and a control system controlling these components.

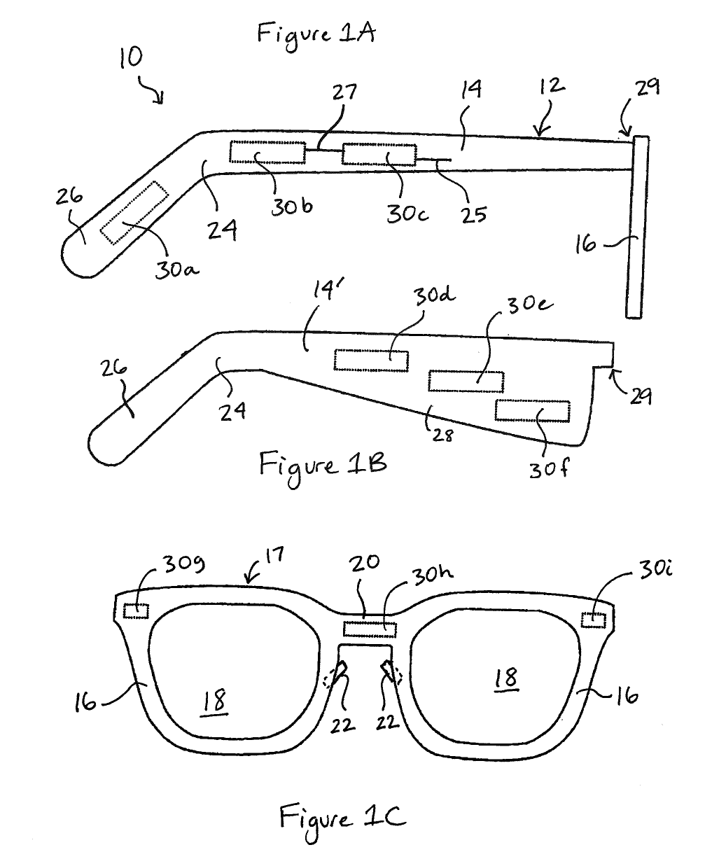

An embodiment of the invention is shown in FIGS. 1A-C. FIG. 1A shows a head-worn electronic device 10 including an eyeglass frame 12. The eyeglass frame 12 includes first and second temples or side arms 14 (only one of which is visible in the side view of FIG. 1A) and first and second optic frames 16 (only one of which is visible in the side view of FIG. 1A). The optic frame 16 may be referred to in the industry as the “eye” of the eyeglass frame. The side arms 14 are connected to the optic frame 16 by a hinge 29. Each optic frame 16 supports an optic 18 (see FIG. 1C), which may be a lens or glass or mirror or other type of reflective or refractive element. The frame 12 also includes a nose bridge 20 which connects the two optic frames 16, and two nose pads 22 that are mounted on the optic frames and that rest on either side of the wearer's nose. The two optic frames 16 and nose bridge 20 make up the front face 17 of the frame 12. Each side arm 14 includes an elbow 24 where the arm curves or bends to form an ear hook 26 which rests behind the wearer's ear.

As shown in FIGS. 1A-1C, the eyeglass frame 12 includes various electrical and/or optical components 30a, 30b, 30c, etc. supported by the frame 12 and powered by electricity and/or light. The components 30 can be MEMS (microelectromechanical systems). In FIG. 1A, the electrical/optical components 30 are supported by the side arm 14. The electrical/optical components 30 may be mounted within the side arm 14, under the top-most layer of the side arm, such as under a top plastic cover layer. Alternatively or in addition, the components 30 may be mounted to the side arm 14 by adhesive, or by printing the electrical/optical components onto a substrate on the side arm 14, or by any other suitable method. The components 30 can be spaced out along the side arm 14 as necessary depending on their size and function. In FIG. 1B, electrical/optical components 30 are shown supported on the wing 28 of the side arm 14′, and they may be located as necessary according to their size and function. In FIG. 1C, the electrical/optical components 30 are supported by the two optic frames 16 and the nose bridge 20. The necessary conductors 27 such as wires or circuit board traces are integrated into the frame 12 to connect and power the various electrical/optical components 30 at their various locations on the frame. An antenna 25 can also be connected to one or more components 30.

The components of the frame 12 can take on various sizes and shapes. For example, an alternate side arm 14′, shown in FIG. 1B, includes a wing 28 that extends down below the hinge 29 and increases the area of the side arm 14′. The larger side arm 14′ can support more electrical/optical components 30 and/or can allow the components 30 to be spaced apart. In other embodiments the side arm 14 and/or optic frame 16 may have other shapes and sizes, including different diameters, thicknesses, lengths, and curvatures.

Particular locations on the eyeglass frame 12 have been discovered to be especially advantageous for certain electrical/optical components. A few examples will be discussed. In FIG. 2, an embodiment is shown in which an eyeglass frame 212 includes electrical/optical components 232 mounted on the nose pads 222 of the eyeglass frame 212. In one embodiment, the electrical/optical components 232 mounted on the nose pads 222 are bone conduction devices that transmit audio signals to the wearer by vibration transmitted directly to the wearer's skull. Bone conduction devices transmit sound to the wearer's inner ear through the bones of the skull. The bone conduction device includes an electromechanical transducer that converts an electrical signal into mechanical vibration, which is conducted to the ear through the skull. In addition to transmitting sound through vibration to the user, the bone conduction device can also record the user's voice by receiving the vibrations that travel through the wearer's skull from the wearer's voice.

Thus, in one embodiment, the electrical/optical components 232 include bone conduction transducers that transmit and receive vibrations to transmit and receive sound to and from the wearer. These bone conduction devices may be mounted anywhere on the frame 212 that contacts the wearer's skull, or anywhere that they can transmit vibrations through another element such as a pad or plate) to the user's skull. In the embodiment of FIG. 2, the devices are mounted on the nose pads 222 and directly contact the bone at the base of the wearer's nose. The inventor has discovered that this location works well for transmitting sound to the wearer as well as receiving the vibrations from the wearer's voice. Bone conduction devices operate most effectively when they contact the user with some pressure, so that the vibrations can be transmitted to and from the skull. The nose pads provide some pressure against the bone conduction devices, pressing them against the user's nose, due to the weight of the eyeglass devices sitting on the nose pads. At this location, the bone conduction devices can transmit sound to the user and can pick up the user's voice, without picking up as much background noise as a standard microphone, since the user's voice is coming directly through the skull.

The eyeglass frame 212 can transmit sounds such as alerts, directions, or music to the wearer through the electrical/optical components 232 and can also receive instructions and commands from the user through the same electrical/optical components 232. In other embodiments, the electrical/optical components 232 mounted on the nose pads 222 may be devices other than bone conduction devices. For example, in one embodiment these components 232 are standard microphones, used to pick up the user's voice as it is spoken through the air, rather than through the skull. Two components 232 are shown in FIG. 2, such as for stereo sound, but in other embodiments only one is provided.

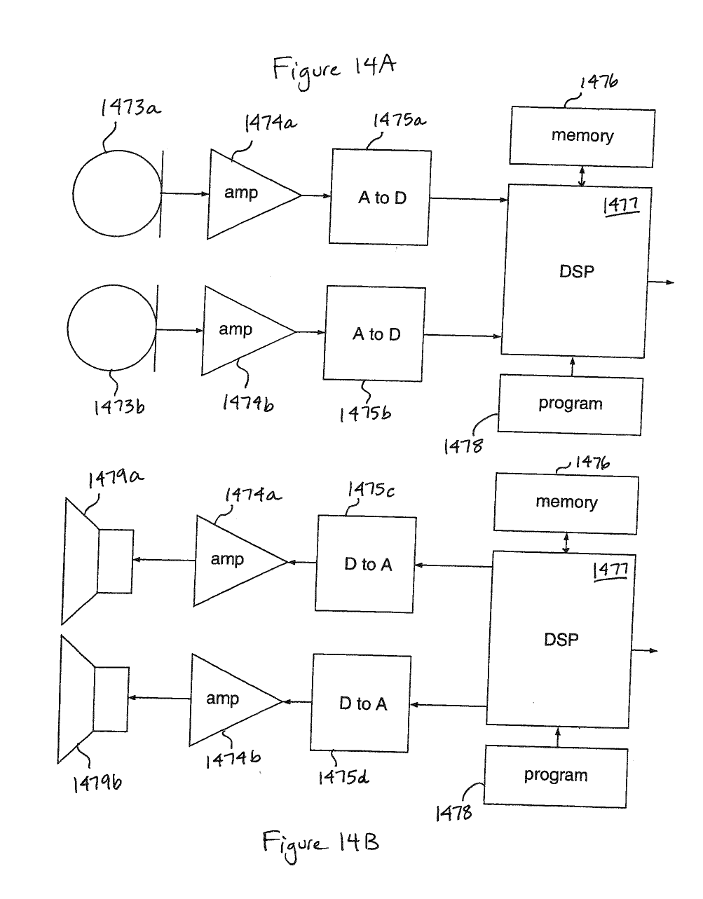

Turning to FIG. 14A, an embodiment of a dual transducer input system is shown in block diagram. FIG. 14A shows two input devices 1473a, 1473b. In one embodiment, device 1473a is a bone conduction sensor that detects sound transmitted through the user's skull, and device 1473b is a microphone that detects sound transmitted through the air. The bone conduction sensor 1473a can detect the user's voice, which will transmit through the skull, and the microphone 1473b can detect other types of noises that do not transmit well through the skull, such as background noises or other noises made by the user (claps, whistles, hisses, clicks, etc). Each of these devices passes the signal through an amplifier 1474a, 1474b, as necessary, and then to an analog-to-digital converter 1475a, 1475b. This converter converts the analog signal from the devices 1473 into a digital signal, and then passes it to a digital signal processor (“DSP”) 1477. The DSP processes the signal according to program 1478, and optionally stores the signal in a memory device 1476.

The DSP can perform various types of digital signal processing according to the particular devices, signals, programming and selected parameters being used. For example, when device 1473a is a bone conduction sensor, the sensor 1473a detects the wearer's voice as it is transmitted through the wearer's skull. However, the user's voice may sound different if it is transmitted through air versus through the skull. For example, a voice may have a different frequency response as heard through the skull than would be picked up by a microphone through the air. Thus, in one embodiment, the DSP adjusts the signal to accommodate for this difference. For example, the DSP may adjust the frequency response of the voice, so that the voice will sound as if it had been detected through the air, even though it was actually detected through the skull. The DSP can also combine signals from multiple devices into one output audio stream. For example, the DSP can combine the user's voice as picked up by the bone conduction sensor 1473a with sounds from the environment picked up by the microphone 1473b. The DSP combines these audio signals to produce a combined audio signal.

In another embodiment, the DSP combines different aspects of speech from the microphone 1473b and from the bone conduction sensor 1473a. For example, at different times during a conversation, one of these sensors may pick up better quality sound than the other, or may pick up different components of sound. The DSP merges the two signals, using each one to compensate for the other, and blending them together to enhance the audio signal. As an example, the DSP may blend in some outside or background noise behind the user's voice. In one embodiment, the user can adjust the amount of background noise, turning it up or down.

In another embodiment, the DSP creates a model of the user's speech, built from data collected from the user's voice. The DSP can then process the signals from the two sensors 1473a, 1473b to create an output signal based on the model of the user's speech. As one example of such processing, sounds from the environment can be distinguished as to whether they are from the user's speech or not, and then those from the speech can be used in the process of enhancing the speech. As explained with respect to FIG. 14B, a related process can take place in reverse, to provide sounds to the user.

FIG. 14B shows a dual transducer output system, for providing output to the wearer. The DSP 1477 creates a digital signal, such an audio or video signal, based on instructions from the program 1478 and/or content stored in memory 1476. The DSP 1477 may create the signal and store it in the memory 1476. The DSP may divide the signal into two signals, one for sending to output device 1479a and another for sending to output device 1479b. For example, device 1479a can be a bone conduction transducer, and device 1479b can be an audio speaker. In such a case, the DSP divides the audio signal into a first component that is transmitted through the skull by the bone conduction transducer 1479a, and a second component that is transmitted through the air by the speaker 1479b. The signals pass through digital-to-analog converters 1475c, 1475d, and then optionally through amplifiers 1474a, 1474b, and finally to the output devices 1479a, 1479b. The two signals may be related to each other, such that when they are both transmitted by the output devices 1479a, 1479b, the user hears a combined audio signal,

In still another embodiment, where multiple bone conduction transducers are used, such as output device 1479a and input device 1473a, one device may in effect listen to the other, and they may be connected to the same or cooperating DSP's. In other words, the sound sent into the skull by one transducer is picked up by another transducer. The DSP 1477 can then adjust the sound, such as intensity or frequency response, so that it is transmitted with improved and more consistent results. In some examples users can adjust the frequency response characteristics for various types of listening.

In another example embodiment, the sound picked up from the environment can be what may be called “cancelled” and/or “masked” in effect for the user by being sent in by bone conduction. For instance, low-frequency sounds may be matched by opposite pressure waves, or the levels of background sound played through the bone conduction may be adjusted responsive to the environmental sounds.

In another embodiment of the invention, shown in FIG. 3, an eyeglass frame 312 includes an electrical/optical component 334 located at about the elbow 324 of one or both side arms 314. This electrical/optical component 334 may be, for example, an audio output transducer, such as a speaker, which creates an audio output. The location of the electrical/optical component 334 near the elbow 324 of the side arm 314 positions the electrical/optical component 334 near the wearer's ear, so that the audio output can be heard by the wearer at a low volume. The electrical/optical component 334 could also be a bone conduction device, as described previously, that contacts the wearer's head just behind the ear and transmits vibrations to the wearer's inner ear through the skull. In FIG. 3, the electrical/optical component 334 is shown on the inside surface of the side arm 314, the surface that faces the wearer when the eyeglass frame 312 is worn. In another embodiment, an electrical/optical component can be supported on the outside surface of the side arm, facing away from the user, such as, for example, the electrical/optical components 30 shown in FIG. 1A.

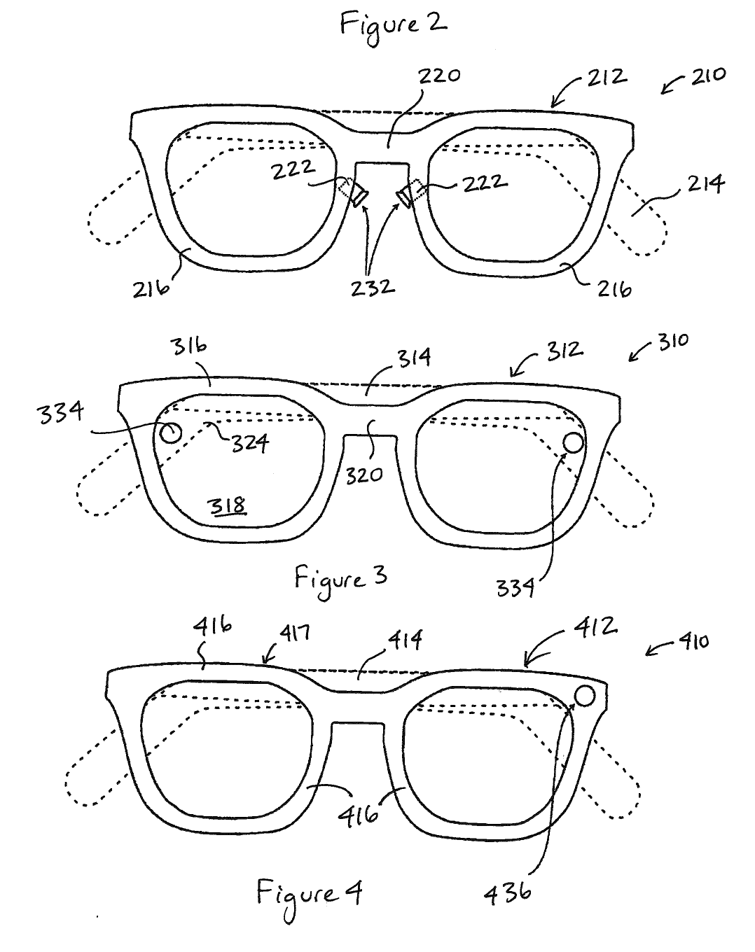

In another embodiment of the invention, shown in FIG. 4, an eyeglass frame 412 includes an electrical/optical component 436 located on one or both optic frames 416 on the front face 417. For example, the component 436 may be a camera or other image sensor located at the top outer corner of the optic frame 416. At this location, the camera can face forward from the wearer and record video or take photographs of the scene in front of the wearer's field of view. Alternatively, the component 436 could face rearward to take video or photographs of the scene behind the wearer. Although only one electrical/optical component 436 is shown in FIG. 4, on one of the two optic frames 416, another component may be located on the other optic frame 416 as well. Other possible examples for the electrical/optical component 436 are described more fully below.

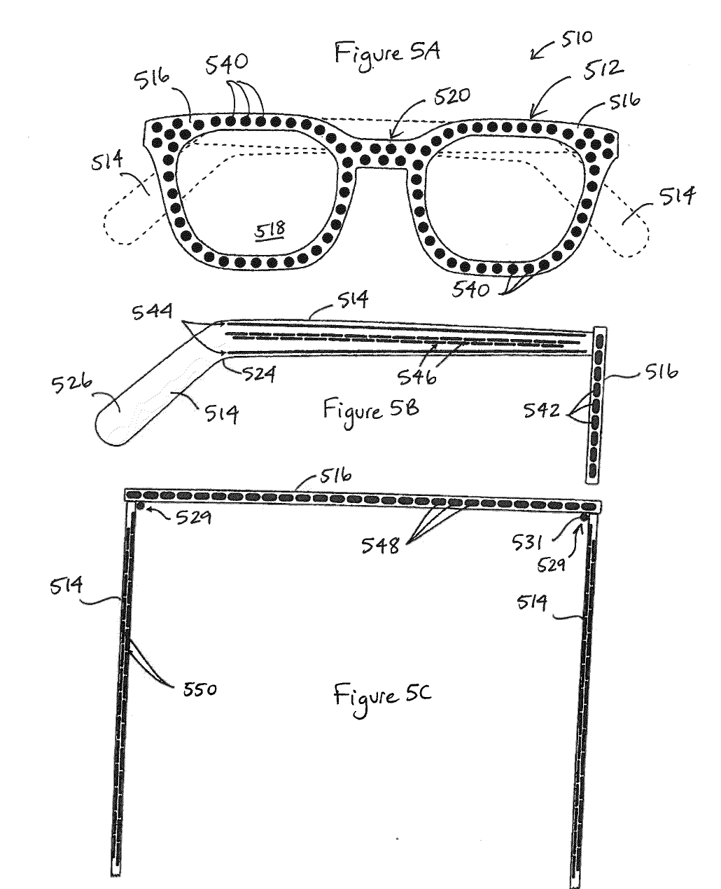

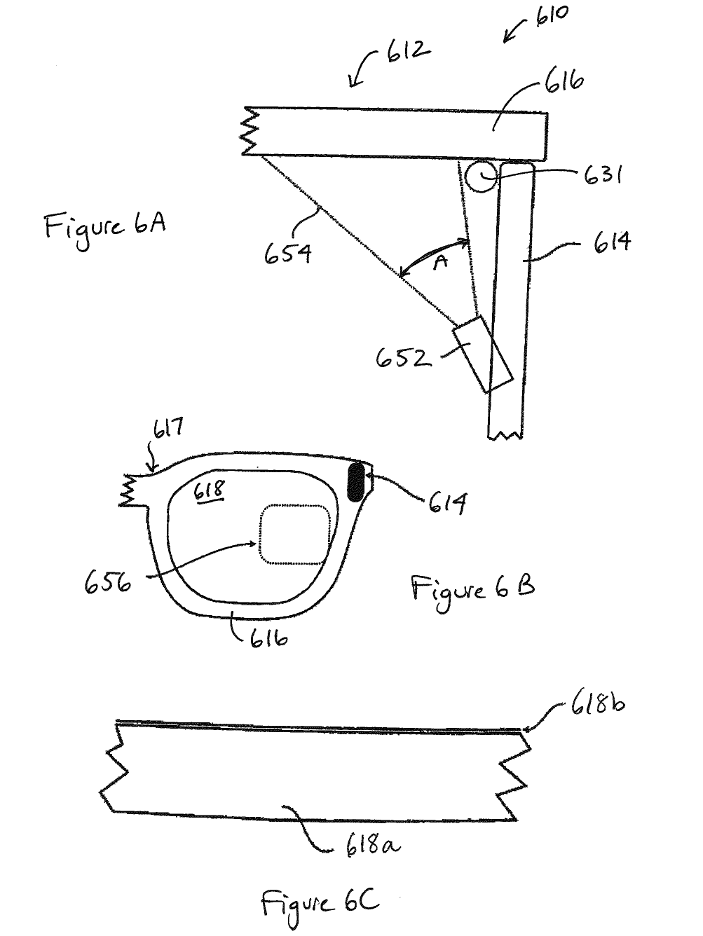

Another embodiment of the invention is shown in FIGS. 5A-5C. As shown in FIG. 5A, an eyeglass frame 512 includes electrical/optical components 540 spaced around the front of the two optic frames 516. In this embodiment, the electrical/optical components 540 may be sensors that obtain input from the user. For example, they may be touch sensors that send a signal to a computer processor or other device on the eyeglass device 510 each time the user touches one of the sensors, or they can be pressure sensitive sensors, static electricity sensors, strain gages, or many other types of sensors or components as described more fully below. The sensors 540 can be spaced apart along each optic frame 516, encircling the optic 518, and along the nose bridge 520. The input from all of the sensors 540 can be correlated by the computer processor to sense movement of the user's fingers along the frame 516. For example, a user could move a finger along one of the optic frames 516 in a circle, around the optic 518, and the computer processor can sense this movement as the user moves from one sensor 540 the next adjacent sensor 540. Different patterns of tactile input can be recognized by the computer processor as different commands from the user. For example, tactile contact along the sensors 540 in a counter-clockwise direction around one of the optic frames 516 can indicate to the computer processor to provide a particular response, such as to have a camera (for example, component 436 in FIG. 4) zoom in or focus, and tactile contact in the clockwise direction can indicate to the computer processor to provide a different response, such as to zoom out or refocus. The user may touch a sensor 540 on the bridge 520 to turn the camera on or off. These are just a few examples of the interaction between the user and the electrical/optical components through the touch sensors.

FIG. 5B shows a side view of the eyeglass frame 512, showing electrical/optical components 542 located along the side of the optic frame 516. These electrical/optical components 542 may also be touch sensors that send signals to the computer when they sense contact from the user. In addition to or in place of touch sensors, these components 542 could include cameras, speakers, microphones, or other electrical devices, depending on how the particular eyeglass device 510 is arranged and what capabilities it is intended to have.

FIG. 5B shows that these components 542 can be placed in many locations along the eyeglass frame 512, including the side of the optic frame 516, and along the side arm 514. The electrical/optical components supported on the side arm 514 can include slider sensors 544 as well as touch sensors 546. Touch sensors 546 are shown as two alternating or staggered rows of discrete sensor strips. When the user touches the side arm 514, the touch sensors 546 staggered along the length of the side arm 514 can identify where along the side arm the user has made contact. The sensor 546 that the user touches sends a signal to the on-board computer, and the location of the sensor can indicate a particular command, such as turning on a camera or uploading a photograph. As another example, the user can move a finger along the length of the side arm 514, along slider sensors 544 or touch sensors 546, to indicate a different type of command, such as to increase or decrease the volume of a speaker. The particular layout and location of electrical/optical components 544, 546 along the length of the side arm 514 can be varied as desired.

FIG. 5C is a top view of the eyeglass frame 512, showing that additional electronic components 548, 550 can be located along the top of the optic frames 516 and side arms 514, respectively. Additionally, as indicated in FIG. 5C, each side arm 514 is connected to the respective optic frame 516 by a hinge 529. The hinge 529 includes a pin 531 about which the side arm 514 rotates with respect to the optic frame 516, to move the frame 512 between open and folded positions. Various options for the hinge will be discussed in more detail below.

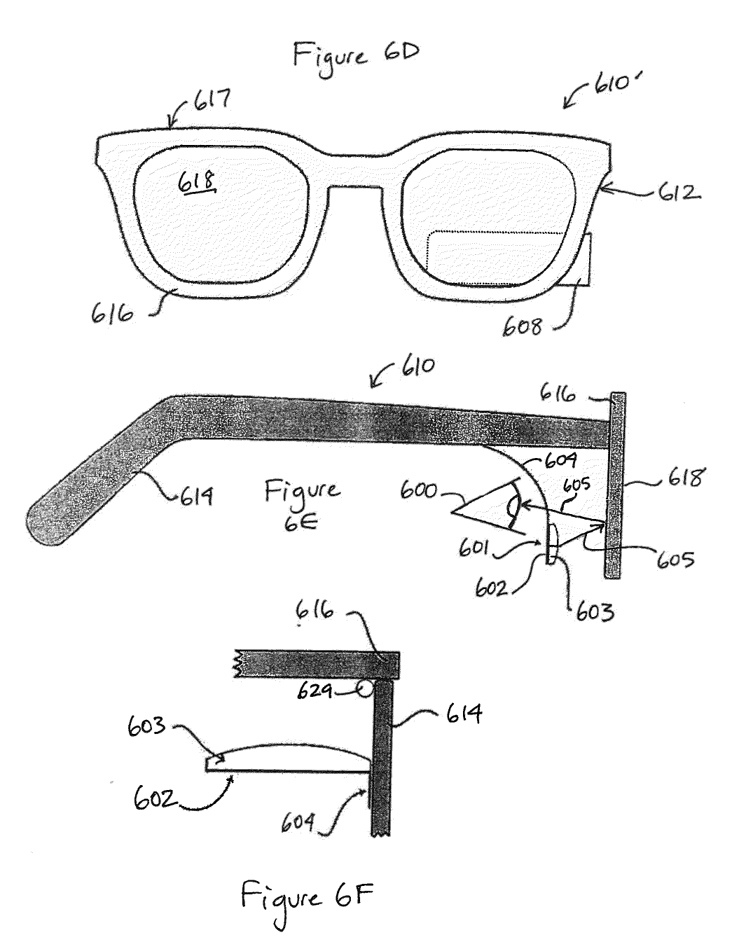

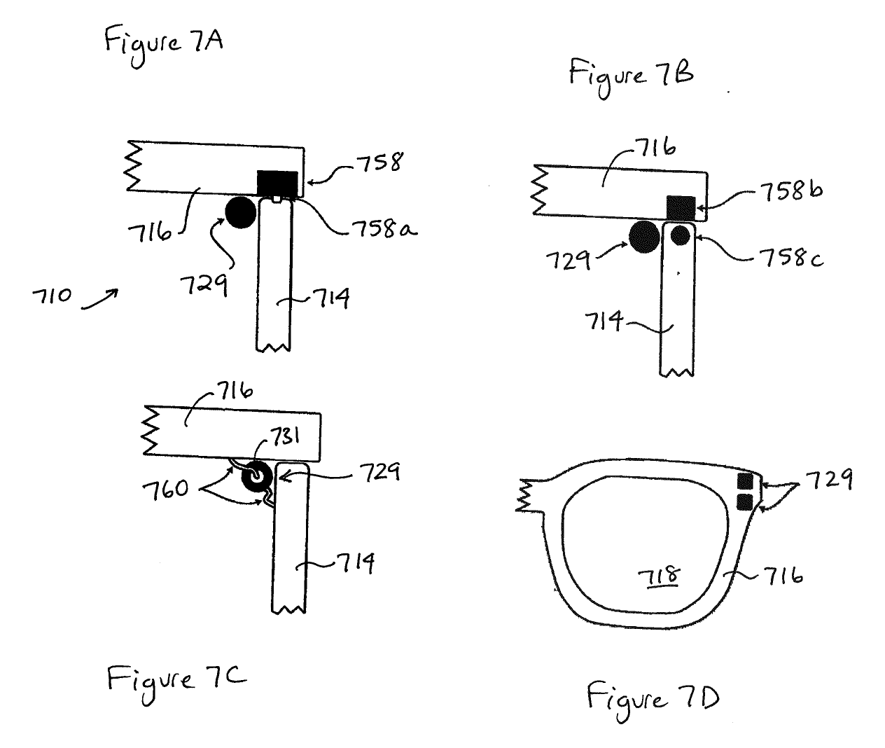

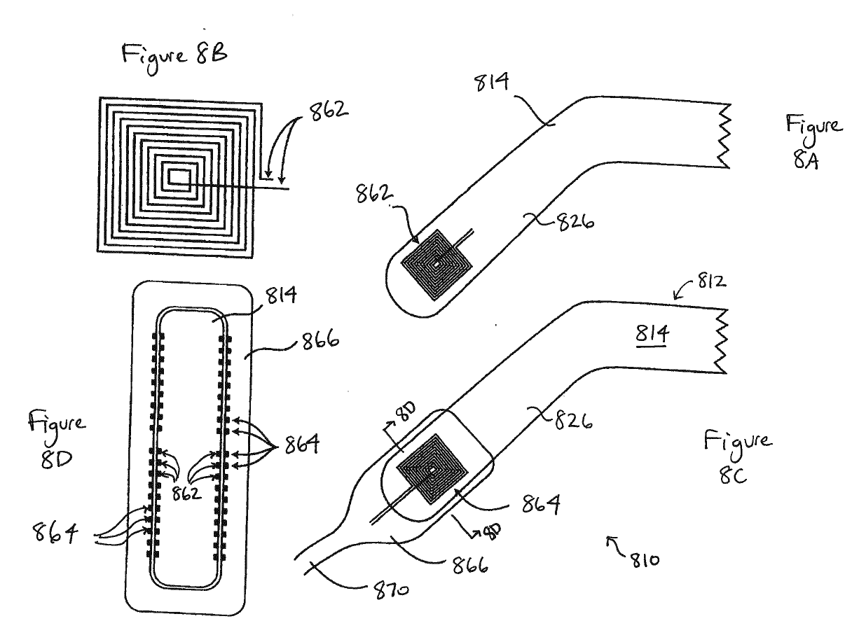

Another embodiment of the invention is shown in FIGS. 6A-6C. The eyeglass frame 612 includes a projector 652 mounted on the side arm 614 and armed toward the optic 618 housed in the optic frame 616. The projector 652 transmits light 654 through an angle A, and the light is reflected from the optic 618 back to the wearer's eye. In this way the projector 652 can project images that are viewable by the wearer. An embodiment of a projector system, including projector 652, light 654, and the reflection of this light by the optic 618 to focus in the user's eye is described in more detail in a co-pending U.S. patent application filed on Monday, Oct. 5, 2009, under attorney docket number 64461/C1273. Embodiments of a projector system are also described in more detail in co-pending U.S. patent application filed concurrently with this application, titled “Near To Eye Display System and Appliance”, identified under attorney docket number 64495/C1273. In the system of the co-pending applications, the optic 618 may be referred to as a “proximal optic”, and it may be incorporated into the optic of a pair of glasses such as the eyeglass device 10, 210, 310, etc disclosed in this application. The entire content of that application is hereby incorporated by reference.

As shown in FIG. 6B, when the projector 652 is operating, the wearer sees an image 656 in the wearer's field of view. The image 656 appears to be projected in front of the wearer's eye, through the optic 618. The projected image 656 in FIG. 6B is located toward the right side of the wearer's field of view, but this can vary in other embodiments. The projector 652 can be designed to project the image 656 at any desired place within the user's field of view. For some applications, it may be desirable to have an image 656 directly in front of the wearer, but for many applications, it may be more desirable to project the image in the periphery of the user's vision. The size of the image 656 can also be controlled by the projector.

The light from the projector 652 is reflected, refracted, or otherwise redirected from the optic 618 (such as a lens) into the eye of the wearer to cause an image to impinge on the retina; similarly, light reflected from the retina, including that projected, as well as light reflected from other portions of the eye can be captured for use as feedback on the position of the wearer's eye(s). FIG. 6C is a cross-section of the example lens 618a indicating that it includes a coating surface 618b, such as preferably on the inner surface. The coating preferably interacts with the projected light to send it into the pupil of the eye and/or return light from the eye to the camera. Coatings are known that reflect substantially limited portions of the visible spectra, such as so-called “dichroic” coatings. These coatings have the advantage that they limit the egress of light from the glasses and can, particularly with narrow “band-pass” design, interfere little with vision by the wearer through the glasses.

The eyeglass frame 612 can have more than one projector, such as one projector on each side arm 614 acting through optics on both sides of the front face 617. The projector(s) 652 can create a virtual reality experience for the wearer, by displaying images in the wearer's field of view. In combination with the other electrical/optical components on the eyeglass device, such as audio transducers, the eyeglass device can provide a virtual reality experience with images and sound. The virtual reality application can even combine elements from the user's surroundings with virtual elements.

Optionally, the projector 652 can include a camera or image sensor as well, to capture light that is reflected from the wearer's eye. This reflected light is used for eye tracking, in order for the device to detect when the user's eye moves, when the pupil dilates, or when the user opens or closes an eye or blinks. In one example type of an eye tracking system, the camera captures images of the eye and particularly the puil, iris, sclera, and eyelid. In order to determine the rotational position of the eye, images of these features of the eye are matched with templates recorded based on earlier images captured. In one example, a training phase has the user provide smooth scrolling of the eye to display the entire surface. Then, subsequent snippets of the eye can be matched to determine the part of the eye they match and thus the rotational position of the eye.

In the embodiment(s) including a projector 652, it may be helpful for the user to be able to adjust the location and orientation of the optic 618 with respect to the frame 612, in order to more properly direct the light from the projector 652 into the user's eye. Exemplary embodiments of an adjustable eyeglass frame are described further below, with respect to FIGS. 16-18.

Another embodiment of the invention is shown in FIGS. 6D-6F. In this embodiment, an eyeglass device 610′ includes a peripheral visual display system 601. This visual display system is located at a periphery of the user's eye and displays images such as image 608 (FIG. 6D) in the periphery of the user's vision. In one embodiment, the image 608 is a low-resolution textual image, such as a text message, a temperature reading, a heart rate reading, a clock, or a news headline. The image is displayed by an illuminator 602 and a lens 603, which are mounted to the eyeglass frame 612 and suspended away from the center of the user's field of view. The image 608 may be quite small, to avoid interfering with the user's view. In one embodiment, the lens has a size of about 2 cm². In one embodiment, the lens 603 and illuminator 602 are suspended from the side arm 614 by a bridge 604, which extends down from the side arm 614.

The illuminator 602 displays an image such as a text message. Light 605 from the illuminator 602 passes through the lens 603 and toward the main optic 618. The light from the illuminator is transmitted by the lens 603, to send it toward the optic 618. The lens 603 compensates for the curve of the optic 618 and the wearer's eyesight. In one embodiment, the lens 603 is removable, such as by being snapped into or out of place. A kit with various lenses can be provided, and the user can select the lens that is appropriate for the user.

The light 605 is then reflected by the optic 618 and directed toward the user's eye 600, as shown in FIG. 6E. In one embodiment, the optic 618 or a portion of the optic 618 does not have an anti-reflective coating, so that the light 605 can be reflected as shown in FIG. 6E. In some embodiments, the optic includes dichroic or other structures that reflect a narrow band of frequencies, or narrow bands in the case of multi-color displays, in order to provide higher reflectivity for the wearer and/or block the image from view by onlookers. Modifications to the reflective characteristics of the inside of the optic 618 can be accomplished by coatings, lenses, stickers, self-adhesive or adhered membranes, or other mechanisms.

The system 601 optionally corrects for the curvature of images reflected in the optic 618, and optionally accommodates for the wearer's eyesight. The optic 618, the lens 603, and the location of the display system 601 are arranged such that the light 605 passes from the illuminator 602 into the user's eye. The result is an image such as image 608 in the periphery of the user's vision. The image system 601 can be turned on or off so that this image is not always present.

The illuminator 602 can consist of a plurality of LED, OLED, electroluminescent elements, a combination of reflective or emmissive elements (such as “interferometric modulation” technology), or other light-generating or light-directing elements. The elements can be closely grouped dots that are selectively illuminated to spell out a message. The elements may have non-uniform spacing between them. Optionally the elements are provided in multiple colors, or they could be all one color, such as all red lights. In one embodiment, the lights are transparent so that the user can see the environment behind the image 608. The user can adjust the brightness of the light-generating elements and the image 608. In one embodiment, the eyeglass system automatically adjusts the brightness of the elements based on an ambient light sensor, which detects how much light is in the surrounding environment.

Although not shown for clarity in FIG. 6F, there is optionally a space between the illuminator 602 and lens 603, such as a small gap of air, for the light from the illuminator to pass through before reaching the lens 603. Also, while the illuminator 602 is shown in the figures as a flat surface, it can be curved.

The bridge 604 can be any suitable connecting member to mount the display system 601 to the frame 612. A metal or plastic piece can connect the lens 603 and illuminating elements 602 to the side arm 614, or to the front face 617. The material can be the same material used for the frame 612. In one embodiment the bridge 604 is rigid, to keep the display system 601 properly aligned. In one embodiment, the bridge 604 includes a damping element such as a damping spring to insulate the display system 601 from vibrations from the frame 612. In another embodiment, the bridge 604 is a bendable member with shape memory, so that it retains its shape when bent into a particular configuration. In this way, the user can bend the bridge to move the display system 601 out of the user's vision, to the side for example, near the side arm 614, and then can bend the bridge again to bring the display system 601 back into use. The bridge 604 can be provided as a retrofit member, such that the system 601 can be added to existing eyeglass frames as an accessory device. Mechanical means for attaching the system 601 to the eyeglasses, such as by attaching the bridge 604 to the side arm, can be provided, including snaps, clips, clamps, wires, brackets, adhesive, etc. The system 601 can be electrically and/or optically coupled to the eyeglass device to which it is attached.

In one embodiment, the display system 601 sits between the user's temple and the side arm 614. The side arm 614 can bend or bulge out away from the user's head, if needed, to accommodate the display system 601. In another embodiment, the display system 601 sits below the user's eye. In another embodiment, the lens 603 is positioned behind the front surface of the user's eye.

There are many potential combinations of electrical/optical components, in different locations on the eyeglass frame, which interact together to provide many applications for the wearer. The following sections describe exemplary categories of electrical/optical components that can be used on the eyeglass device, including “infrastructure” components (computer processor, storage, power supply, communication, etc), “input” devices (touch sensors, cameras, microphones, environmental sensors), and “output” devices (image projectors, speakers, vibrators, etc). The various types of sensors described below are intended to be exemplary and nonlimiting examples. The embodiments described are not intended to be limited to any particular sensing or other technology.

The “input” devices include electrical/optical components that take input such as information, instructions, or commands from the wearer, or from the environment. These devices can include audio input devices, such as audio transducers, microphones, and bone conduction devices, which detect audio sounds made by the user. These devices can detect voice commands as well as other sounds such as clapping, clicking, snapping, and other sounds that the user makes. The sound can be detected after it travels through the air to the audio device, or after it travels through the user's skull (in the case of bone conduction devices). The audio input devices can also detect sounds from the environment around the user, such as for recording video and audio together, or simply for transmitting background sounds in the user's environment.

Another type of input device detects eye movement of the wearer. An eye tracker can detect movement of the user's eye from left to right and up and down, and can detect blinks and pupil dilation. The eye tracker can also detect a lack of movement, when the user's eye is fixed, and can detect the duration of a fixed gaze (dwell time). The eye tracker can be a camera positioned on the eyeglass frame that detects reflections from the user's eye in order to detect movement and blinks. When the eyeglass frame includes an eye tracker, the user can give commands to the device simply by blinking, closing an eye, and/or looking in a particular direction. Any of these inputs can also be given in combination with other inputs, such as touching a sensor, or speaking a command.

Another category of input devices includes tactile, touch, proximity, pressure, and temperature sensors. These sensors all detect some type of physical interaction between the user and the sensors. Touch sensors detect physical contact between the sensor and the user, such as when the user places a finger on the sensor. The touch sensor can be a capacitive sensor, which works by detecting an increase in capacitance when the user touches the sensor, due to the user's body capacitance. The touch sensor could alternatively be a resistance sensor, which turns on when a user touches the sensor and thereby connects two spaced electrodes. Either way, the touch sensor detects physical contact from the user and sends out a signal when such contact is made. Touch sensors can be arranged on the eyeglass frame to detect a single touch by the user, or multiple finger touches at the same time, spaced apart, or rapid double-touches from the user. The sensors can detect rates of touch, patterns of touch, order of touches, force of touch, timing, speed, contact area, and other parameters that can be used in various combinations to allow the user to provide input and instructions. These touch sensors are commercially available on the market, such as from Cypress Semiconductor Corporation (San Jose, Calif.) and Amtel Corporation (San Jose, Calif.), Example capacitive sensors are the Analog Devices AD7142, and the Quantum QT118H.

Pressure sensors are another type of tactile sensor that detect not only the contact from the user, but the pressure applied by the user. The sensors generate a signal as a function of the pressure applied by the user. The pressure could be directed downwardly, directly onto the sensor, or it could be a sideways, shear pressure as the user slides a finger across a sensor,

Another type of tactile sensor is proximity sensors, which can detect the presence of a nearby object (such as the user's hand) without any physical contact. Proximity sensors emit, for example, an electrostatic or electromagnetic field and sense changes in that field as an object approaches. Proximity sensors can be used in the eyeglass device at any convenient location, and the user can bring a hand or finger near the sensor to give a command to the eyeglass device. As with touch sensors, proximity sensors are commercially available on the market.

Temperatures sensors can also be mounted on the eyeglass frame to take input from the user, such as by detecting the warmth from the user's finger when the sensor is pressed. A flexure sensor, such as a strain gage, can also take input by the user by detecting when the user presses on the eyeglass frame, causing the frame to bend,

Another input device is a motion or position sensor such as an accelerometer, gyroscope, magnetometer, or other inertial sensors. An example is the Analog Devices ADIS 16405 high precision tri-axis gyroscope, accelerometer, and magnetometer, available from Analog Devices, Inc. (Norwood, Mass.). The sensor(s) can be mounted on the eyeglass frame. The motion or position sensor can detect movements of the user's head while the user is wearing the glasses, such as if the user nods or shakes his or her head, tilts his or her head to the side, or moves his or her head to the right, left, up, or down. These movements can all be detected as inputs to the eyeglass device. These movements can also be used as inputs for certain settings on the eyeglass device. For example, an image projected from the eyeglass device can be fixed with respect to the ground, so that it does not move when the user moves his or her head, or can be fixed with respect to the user's head, so that it moves with the user's head and remains at the same angle and position in the user's field of view, even as the user moves his or her head.

The eyeglass device can also include standard switches, knobs, and buttons to obtain user input, such as a volume knob, up and down buttons, or other similar mechanical devices that the user can manipulate to change settings or give instructions. For example a switch on the side arm can put the eyeglass device into sleep mode, to save battery life, or can turn a ringer on or off, or can switch to vibrate mode, or can turn the entire device off.

Another type of input devices is environmental sensors that detect information about the user's environment. These can include temperature sensors mounted on the eyeglass frame to detect the surrounding ambient temperature, which could be displayed to the user. Another sensor could detect humidity, pressure, ambient light, sound, or any other desired environmental parameter. An echo sensor can provide information through ultrasonic ranging. Other sensors can detect information about the wearer, such as information about the wearer's health status. These sensors can be temperature sensors that detect the wearer's temperature, or heart rate monitors that detect the wearer's heart beat, or pedometers that detect the user's steps, or a blood pressure monitor, or a blood sugar monitor, or other monitors and sensors. In one embodiment, these body monitors transmit information wirelessly to the eyeglass device. Finally, another type of environmental sensor could be location sensor such as a GPS (global positioning system) receiver that receives GPS signals in order to determine the wearer's location, or a compass.

Finally, input devices also include cameras of various fowls, which can be mounted as desired on the eyeglass frame. For example, an optical camera can be positioned on the front of the optic frame to face forward and take images or videos of the user's field of view. A camera could also be faced to the side or back of the user, to take images outside the user's field of view. The camera can be a standard optical camera or an infrared, ultra-violet, or night vision camera. The camera can take input from the user's environment, as well as from the user, for example if the user places a hand in front of the camera to give a command (such as to turn the camera off), or raises a hand (such as to increase volume or brightness). Other gestures by the user in front of the camera could be recognized as other commands.

The next category of electrical/optical components that can be included in various embodiments of the eyeglass device are output devices. Output devices deliver information to the wearer, such as text, video, audio, or tactile information. For example, one type of output device is an image projector, which projects images into the wearer's eye(s). These images can be still or video images, including email, text messages, maps, photographs, video clips, and many other types of content.

Another type of output device is audio transducers such as speakers or bone conduction devices, which transmit audio to the wearer. With the ability to transmit audio to the wearer, the eyeglass device can include applications that allow the wearer to make phone calls, listen to music, listen to news broadcasts, and hear alerts or directions.

Another type of output device is tactile transducers, such as a vibrator. As an example, the eyeglass device with this type of transducer can vibrate to alert the user of an incoming phone call or text message. Another type of output device is a temperature transducer. A temperature transducer can provide a silent alert to the user by becoming hot or cold.

The next category of electrical/optical components includes infrastructure components. These infrastructure components may include computer processors, microprocessors, and memory devices, which enable the eyeglass device to run software programming and store information on the device. The memory device can be a small hard drive, a flash drive, an insertable memory card, or volatile memory such as random acess memory (RAM). These devices are commercially available, such as from Intel Corporation (Santa Clara, Calif.). The computer system can include any specialized digital hardware, such as gate arrays, custom digital circuits, video drivers, digital signal processing structures, and so forth. A control system is typically provided as a set of programming instructions stored on the computer processor or memory device, in order to control and coordinate all of the different electrical/optical components on the eyeglass device.

Infrastructure devices can also include a power source, such as on-board batteries and a power switch. If the batteries are re-chargeable, the eyeglass device can also include the necessary connector(s) for re-charging, such as a USB port for docking to a computer for recharging and/or exchanging content, or a cable that connects the device to a standard wall outlet for recharging. Exemplary re-charging components are described in more detail below.

The infrastructure devices can also include communications devices such as antennas, Bluetooth transceivers, WiFi transceivers, and transceivers and associated hardware that can communicate via various cellular phone networks, ultra-wideband, irDA, TCP/IP, USB, FireWire, HDMI, DVI, and/or other communication schemes. The eyeglass can also include other hardware such as ports that allow communications or connections with other devices, such as USB ports, memory card slots, other wired communication ports, and/or a port for connecting headphones.

Additionally, the eyeglass device can include security devices such as a physical or electronic lock that protects the device from use by non-authorized users, or tamper-evident or tamper-responding mechanisms. Other security features can include a typed or spoken password, voice recognition, and even biometric security features such as fingerprints or retina scanning, to prevent unauthorized use of the device. If an incorrect password is entered or a biometric scan is failed, the device can send out alerts such as an audio alarm and an email alert to the user.

The eyeglass device can also include self-monitoring components, to measure its own status and provide alerts to the user. These can include strain gages that sense flexure of the eyeglass frame, and sensors to detect the power level of the batteries. The device can also have other accessory devices such as an internal clock.

Additionally, the “infrastructure” components can also include interfaces between components, which enable parts of the device to be added or removed, such as detachable accessory parts. The device can include various interfaces for attaching these removable parts and providing power and signals to and from the removable part. Various interfaces are known in the art, including electrical, galvanic, optical, infrared, and other connection schemes.

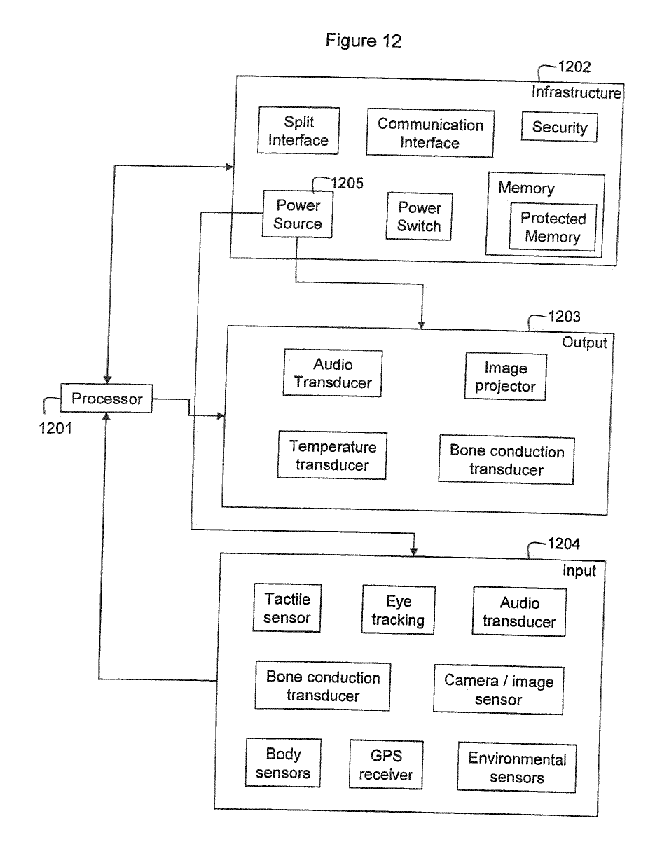

FIG. 12 is a block diagram showing exemplary infrastructure, output, and input devices. A processor 1201 communicates back and forth with infrastructure devices 1202. The processor 1201 sends information to output devices 1203, and receives information from input device 1204. All of the devices are connected to a power source 1205, which can supply electrical or optical power to the various devices.

The system may also utilize protected program memory, as shown in FIG. 12. The firmware and/or software controlling the systems on each integrated device preferably contains cryptographic algorithms that are used to verify signatures on code updates and/or changes and preferably to decrypt same using keying matter that is securely stored and used. The use of cryptographic algorithms and encrypted programs can make it difficult for malicious software or users to interfere with operation of the system.

These various electrical/optical components can be mixed and matched to create a particular eyeglass device with the desired capabilities for the wearer. For example, an eyeglass device with an audio speaker, microphone, touch sensors, image projector, wifi connection, on-board processor, memory, and batteries can be used to browse the Internet, and download and send email messages. The computer can make a sound, such as a chime sound, when the user receives a new email, and the user can state a command, such as the word “read,” to instruct the device to display the new email message. The image projector can then display the new email message. The user can then respond to the email by typing a new message via the touch sensors, and then can state “send” or some other command to send the email. This is just one example, and there are many possible combinations of input, output, and content. The wearer can customize his or her eyeglass device to take commands in a particular way (voice, tactile, eye tracking, etc) and to provide alerts and information in a particular way (displaying an icon, making a chime sound, vibrating, etc). The particular content that is provided can be customized as well, ranging from email, text messages, and web browsing to music, videos, photographs, maps, directions, and environmental information.

As another example, the user can slide a finger along the sensors 544 or 546 on the side of the side arm 514 to increase or decrease the volume of music or audio playback. The user can circle a finger around the sensors 540 on the front of the optic frame 516 to focus a camera, darken or lighten an image, zoom in on a map, or adjust a volume level. The user can type on the sensors 546 or 542 (see FIG. 5B), tapping individual sensors or even tapping sensors together in chords, to type an email or select a song or provide other instructions. The user can grasp the side arm between thumb and finger to have the sensors on the side of the side arm act as a keyboard. One sensor at a certain position can even act as a shift key for the user to press, to have additional inputs. Given these dynamic controls, the image projector can display the control options to the user so that he or she knows which sensors correspond to which inputs. The user can slide a finger along the side of the side arm to scroll up or down a webpage that is displayed by the image projector. The image projector can display an email icon when a new email arrives, and the user can look at this icon and blink in order to have the email opened and displayed. The user can press a button and state the word “weather”, and the image projector will display current weather information from the on-board environmental sensors and/or from the Internet. The user can make a clicking sound to select an icon or bring up a home page.

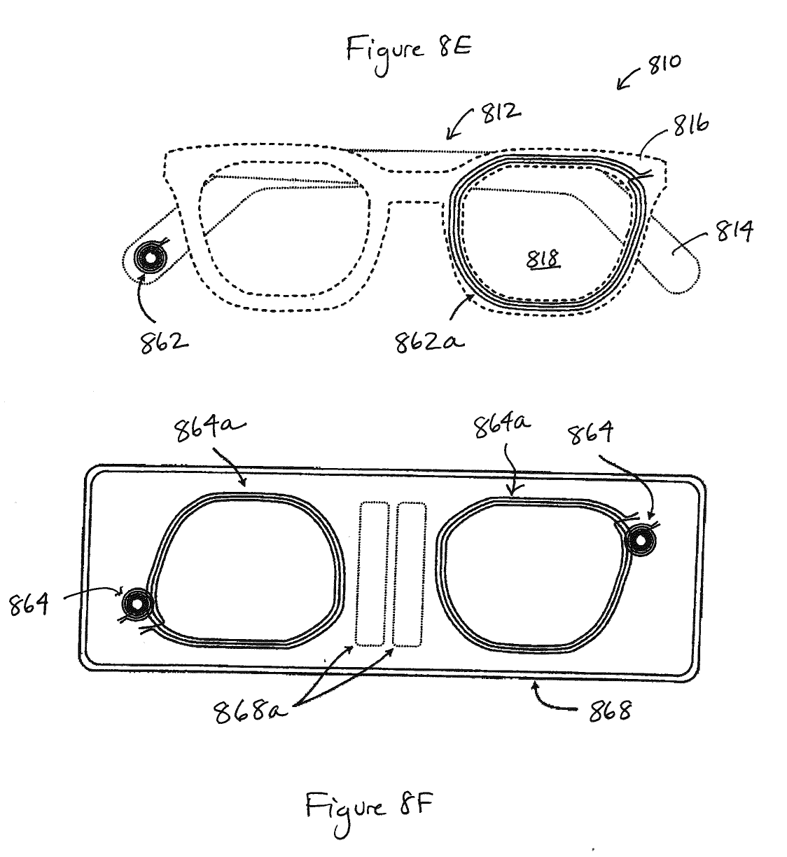

Exemplary features of the eyeglass device will now be described. In the embodiment of FIG. 7A, the eyeglass frame 712 includes a hinge 729 that connects the side arm 714 and optic frame 716. In this embodiment, a power switch 758 is mounted on the optic frame 716 to interact with the side arm 714. When the side arm 714 is rotated about the hinge 729 into the open position (shown in FIG. 7A), the side arm 714 depresses a button 758a extending from the switch 758. When the button is depressed, power is supplied to the electrical/optical components on the eyeglass frame 712. When the wearer is finished using the eyeglass device, he or she removes the eyeglass frame 712 and rotates the side arm 714 about the hinge 729 into a folded position, for storage. The side arm 714 moves away from the switch 758, releasing the button 758a. When the button is released, power is disconnected from the electrical/optical components. The button can be spring-loaded to return to the released position, disconnecting power, when the eyeglass frame is folded. Switches of this type are commercially available, such as the DH Series switches manufactured by Cherry/ZF Electronics Corporation (Pleasant Prairie, Wis.) or the D2SW-P01H manufactured by Omron Corporation (Japan).

In one embodiment, a single switch such as switch 758 is provided at one hinge 729. In another embodiment, two switches 758 are provided, one at each hinge 729, and power is connected to the device only when both side arms 714 are rotated into the unfolded, open orientation.

FIG. 7A is one example of a power switch, and the switch could take other forms. For example, in FIG. 7B, the power switch 758′ is a reed switch, which includes switch 758b and magnet 758c. When the side arm 714 is unfolded, the magnet 758c is near the switch 758b. The magnet closes the switch, which then provides power to the eyeglass frame. When the side arm 714 is folded, the magnet 758c rotates away from the switch 758b, and the switch is opened and power disconnected. In other embodiments, the power switch for the eyeglass frame is not associated with the hinge, but is located on a different area of the eyeglass frame. The power switch can be a mechanical switch manipulated by the user, or an electronic switch or sensor. Electronic switches typically require some backup power even when the device is off, much like a sleep mode, in order for them to operate.

FIG. 7C shows how power and signals can be transferred between the side arm 714 and optic frame 716. In the embodiment shown, the hinge 729 includes a hollow pin 731 about which the side arm 714 rotates. One or more wires or cables 760 pass from the optic frame 716, through the center of this hollow pin 731, to the side arm 714. In this way, power and signals can travel between the side arm 714 and optic frame 716 even when they are separated by the hinge 729. The cables can be electrical cables and/or fiber optic cables for transmitting light. In other embodiments, other mechanisms for transferring power and signals through the hinge can be used, such as slip ring, which keeps the side arm 714 in communication with the optic frame 716 even as the side arm 714 rotates about the hinge. Further exemplary embodiments of a hinge arrangement are described below.

FIG. 7D shows an embodiment in which the hinge 729 is formed with two separate hinge parts. The hinge from the side arm 714 fits between these two separate parts to complete the hinge. At certain angular positions, the hinge allows power or signals to pass through the hinge, and at other angular positions the hinge interrupts the power or signals. The two hinge components on the optic frame 716 are insulated from each other, with the power or signal passing through the cooperating hinge on the side arm 714. In one embodiment, the hinge 729 acts as a slip ring, transferring power or signals, without acting as a switch. In other embodiments, the hinge acts as a switch, and in other embodiments, it provides both functions.

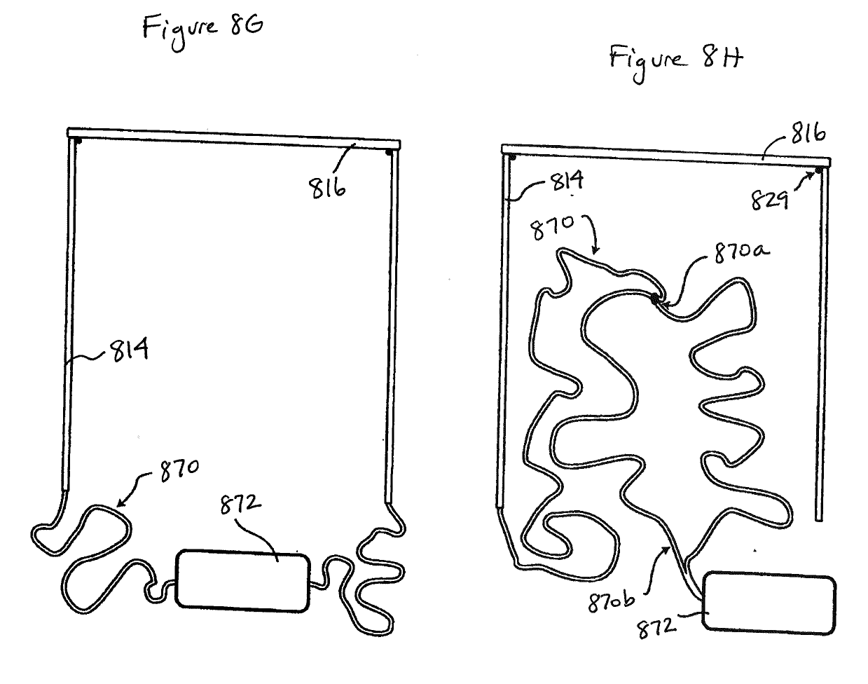

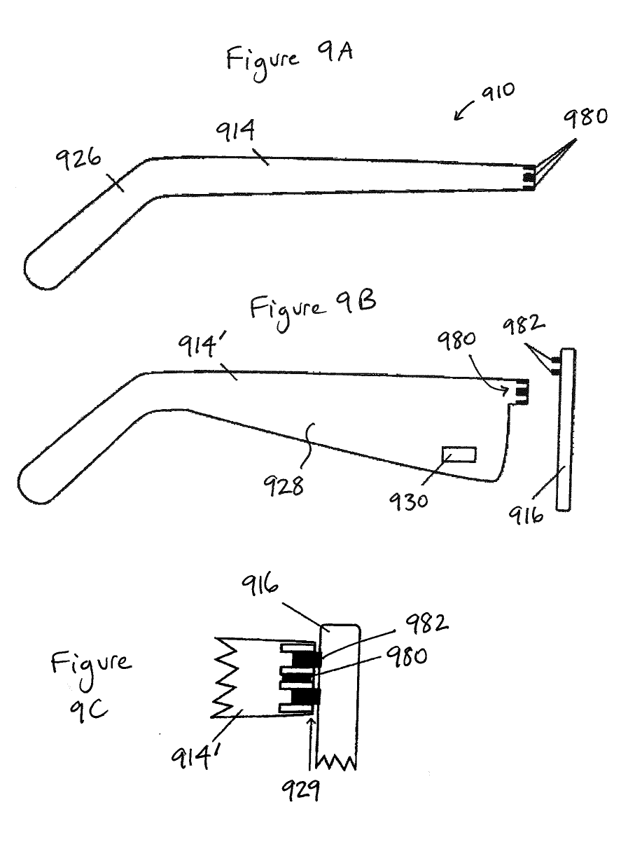

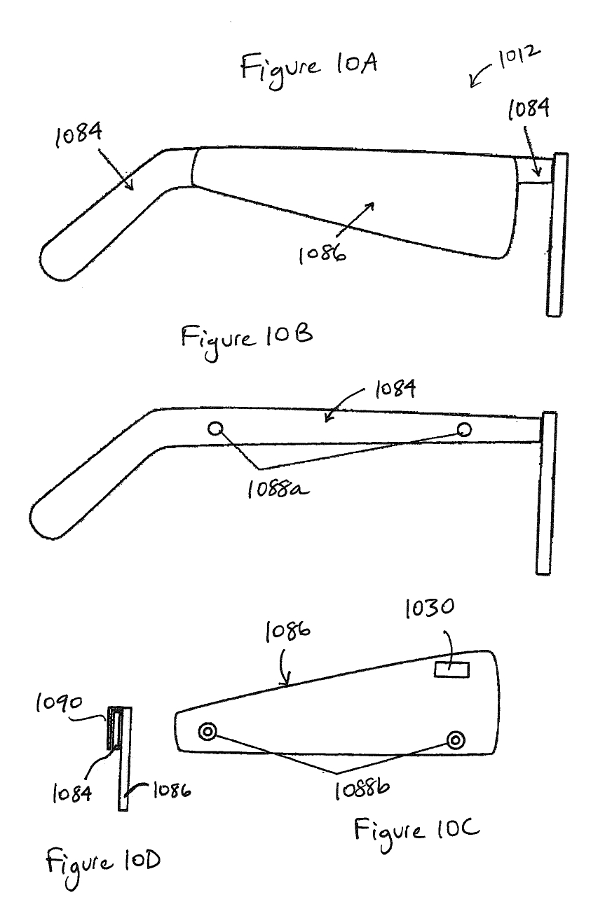

FIGS. 8A-F show embodiments of the invention in which an eyeglass device 810 communicates power and/or signals through one or more coils disposed on the eyeglass frame 812. Alternatively, the eyeglass device communicates power and/or signals through capacitive surfaces on the eyeglass frame 812. For example, as shown in FIG. 8A, the side arm 814 includes a coil structure 862 located at the end of the side arm, at the end of the ear hook 826. An enlarged view of this coil 862 is shown in FIG. 8B. This coil 862 interacts with a separate coil in a charging device, such as coil 864 in boot 866, as shown in FIG. 8C. The boot 866 fits over the end of the ear hook 826, positioning its own coil 864 in close proximity with the first coil 862 on the side arm 814. A cross-sectional view is shown in FIG. 8D, to show the proximity of the two coils 862, 864. In the embodiment shown, the side arm 814 includes a coil 862 on each side surface of the side arm, and the boot 866 also has two coils 864 on each inside surface of the boot. The boot 866 may be made of an elastic material, so that it stretches over the ear hook 826 and remains in place due to the elasticity of the boot 866 itself. Friction between the boot 866 and ear hook 826 can also hold the boot in place, or the boot can be retained by other means such as snaps, hooks, magnets, loops, etc.

When the coils 862, 864 face each other in close proximity, as shown in FIG. 8D, the eyeglass device 812 can be charged through inductive charging. The coil 864 in the boot 866 is connected to a power supply, such as an alternating current electrical power outlet. The electrical current flowing through the coil 864 creates an alternating electromagnetic field. The coil 862 in the eyeglass side arm 814 converts this electromagnetic field back into electrical current to charge the batteries on-board the eyeglass frame 812. By placing the two coils 862, 864 in close proximity, this charging can take place without any direction contact between the two coils. Information signals can also be passed from the boot 866 to the eyeglass frame 812 by modulating the current and the electromagnetic field or other means known in the art.

The location of the coil 862 on the eyeglass frame 812 is not limited to the end of the side arm 812. As shown in FIG. 8E, another coil 862a can be provided on one or both optic frames 816, encircling the optic 818. This optic coil 862a interacts with a corresponding coil 864a which can be located, for example, in a storage case 868 (see FIG. 8F). When the eyeglass device 812 is not in use, or when it needs to be charged, it is placed in the case 868 with the optic coil 862a on the eyeglass frame facing the coil 864a in the case 868. The case 868 has its own power connectors 868a that provide power to the case, such as by connecting it to a wall outlet and/or information infrastructure or device, and the eyeglass device can be charged by inductive charging through the coils 864a, 862a.

In the embodiment shown in FIG. 8F, the case 868 has optic coils 864a on both sides of the case, so that the charging can take place regardless of which way the eyeglass frame 812 is placed in the case. Alternatively, only one coil 864a can be included in the case 868, and the user will simply need to place the eyeglass frame 812 in the proper orientation so that the coils 862a, 864a face each other. In another alternate embodiment, coils 862a can be provided around both optic frames 816, although only one is shown in FIG. 8E.

In the embodiment shown in FIG. 8F, the case 868 also includes smaller coils 864 that interact with the coil 862 at the end of the side arm 814. Thus, the coil 864 can be provided in the charging case 868 or in a boot 866 that fits over the side arm 814. Four coils 864, 864a are shown in the case 868 in FIG. 8F, in order to allow for the eyeglass device to couple with the coils regardless of the orientation of the eyeglass frame in the case 868 (upside down, facing forward, flipped left-for-right). Any orientation of the frame in the case allows coupling. However, in other embodiments, less than four coils are provided in the case 868. Four, three, two, or even just one coil may be provided, in which case the eyeglass frame 812 will couple with the coil when stored in the appropriate orientation in the case 868.

The coils 862, 864 can pass power and communication signals to the eyeglass frame through inductive charging, as just described. As another example, the eyeglass device can communicate by capacitive charging, by placing capacitive surfaces in proximity and/or in contact with each other. Also, the eyeglass frame 812 can include a connection for direct coupling with a charging device. The eyeglass frame can have a male or female connector that connects with a corresponding male or female connector on a charging device, to provide electrical current through direct wired contact.

In addition to charging the eyeglass device 810, the case 868 can transfer signals to the eyeglass device 810, such as updating clocks and calendars, or uploading or downloading content. The case 868 can act as a base station, and the eyeglass frame 810 can be placed in the base for docking synchronization and data transfer.

In one embodiment, the boot 866 is formed as the end of a lanyard or cord 870 that connects to the other side arm 814, forming a loop with the eyeglass frame 812, as shown for example in FIGS. 8G-H. In the embodiment of FIG. 8G, the lanyard 870 connects the two side arms 814, and also connects to a package 872. The package 872 can include, for example, electrical/optical components that interact with the eyeglass frame 812 but are not mounted on the eyeglass frame. For example, the package 872 can include batteries that re-charge the batteries on-board the eyeglass frame 812. When batteries onboard the frame 812 need recharging, or when the eyeglass device 810 needs to be powered, the lanyard 870 can be connected, to transmit power from the batteries in the package 872 to the frame 812. The lanyard 870 can transmit this power through inductive charging or direct contact, as described above. The lanyard itself may include power cables, electrical wires, and/or fiber optic cables for transmitting power and signals between the package and the eyeglass frame. The lanyard can even act as an antenna itself

In other embodiments, the package 872 can include other electrical/optical components, such as accessory devices that the user can connect when desired. For example, the package 872 can include an MP3 player or radio transceiver that the user connects via the lanyard 870 in order to listen to music, and then disconnects and stores for later use. The package 872 could include a GPS receiver that the user can use when desired, and then stores when not in use. The package can include a light source for use with an image projector, such as projector 652. The package can include a computer processor, hard drive, memory, and other computer hardware. The package can include audio microphones to augment sound capture, and/or additional touch panel surfaces for user input. The user can touch the package 872 and receive feedback from the eyeglass device 810.

In another embodiment, the package 872 includes electrical/optical components that communicate wirelessly with the eyeglass frame 812, such as by radio frequency, optical, audio, or other means. In this embodiment, the lanyard 870 may mechanically connect to the side arms 814 without any inductive coils or any direct electrical connection, as the communication between the package 872 and the frame 812 is done wirelessly. In this case, the package 872 could even be separate from the eyeglass frame 812 entirely, perhaps carried on the user's belt or wristwatch, or in a backpack or purse, or even as a skin patch.

FIG. 8H shows another embodiment in which the lanyard 870 attaches to only one side arm 814, and a connector 870a forms the lanyard into a loop or necklace 870b that the user can wear or loop around another item as is convenient. The package 872 is carried on the loop 870b. In one embodiment, the package 872 is decorative, and provides an anchor for the lanyard 870.

The lanyard 870 can attach to the eyeglasses with a boot, such as boot 866, that slides over and surrounds the end of the side arm 814. Alternatively, the lanyard can attach with simple rubber clips that slide over the end of the side or with magnet, or other mechanical hooks. In another embodiment, the lanyard is permanently connected to the side arm 814, rather than being removable.

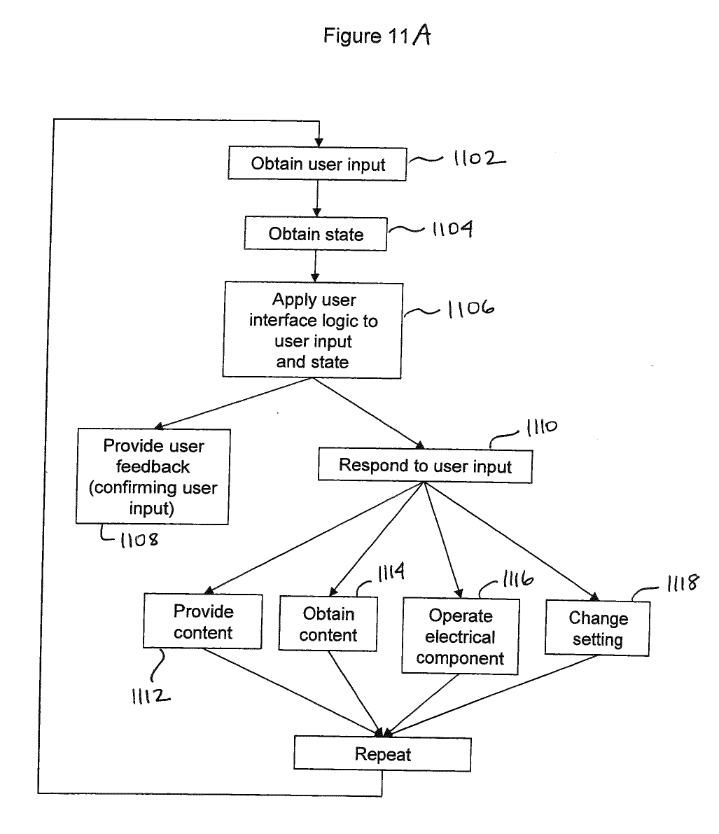

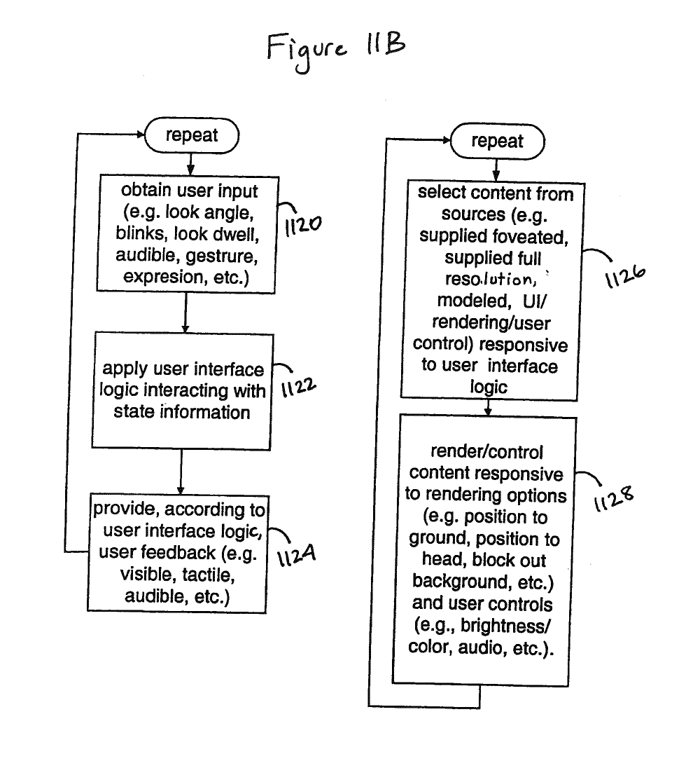

The eyeglass device of the present invention can be formed as interchangeable components that can be swapped or switched out as desired. For example, in the embodiment of FIGS. 9A-9C, the side arm 914 can be detached from the hinge 929, and a replacement side arm 914′ with one or more different electrical/optical components 930 can be attached. This feature enables the user to switch out side arms to provide different capabilities, as desired. For example, the electrical/optical components 930 on the replacement side arm 914′ can provide capabilities that the user needs only in certain situations, such as a night-vision camera, or a GPS receiver, or other electrical devices with their own unique capabilities. The user can select between a set of various different replacement side arms, depending on which electrical/optical components and capabilities the user needs for a given situation. In one embodiment, a replacement side arm may not have any electrical/optical components, or may have the same functionality as another side arm, but it provides a different style or color or decorative function.

As shown in FIGS. 9A-9B, clips 980 on the side arms 914, 914′ connect to projections 982 on the optic frame 916 to form the hinge 929. An enlarged view of this connection is shown in FIG. 9C. The projections 982 fit between the clips 980 and can rotate between them, allowing the side arm 914, 914′ to rotate between folded and extended positions. The hinge 929 can pass power and signals between the side arm 914 and optic frame 916 through the connections between the clips 980 and projections 982. The clips 980 are spaced apart from each other with an insulating material, to prevent a short circuit between the electrical paths provided on the clips. The projections 982 are similarly spaced. When the clips and projections are snapped together, they form electrical paths between them so that power and signals can be transmitted through the hinge. The clips and projections may also be referred to as hinge knuckles, which mate together to form the rotating hinge. The clips and projections can be snapped together by mating a ball into a curved cavity between each clip and projection (not shown for clarity), with the outer projections deflecting out and then snapping back into place to receive the clips in between.

In another embodiment, an eyeglass device 1012 is formed by providing a separate attachment unit 1086 that is fastened to a pair of traditional eyeglasses 1084, as shown in FIGS. 10A-D. In this embodiment, a standard pair of eyeglasses can be retrofitted to provide new capabilities, without having to replace the user's existing eyeglasses. The separate attachment unit 1086 can be attached to the eyeglasses 1084 by fasteners 1088, such as magnets, clips, snaps, clamps, or corresponding male and female fasteners 1088a, 1088b, or by hooking the attachment unit over the eyeglass arm with a hook 1090 (see FIG. 10D). The attachment unit 1086 is shown flipped top over bottom in FIG. 10C, to reveal the fasteners 1088b that mate with the fasteners 1088a on the side arm of the eyeglasses 1084. The attachment unit 1086 can also be attached to an electronic eyeglass device, for example device 810, (rather than a traditional pair of glasses 1084) to provide additional utilities to the electronic eyeglass device. In this case, the attachment unit 1086 may also couple to exchange power and signal with the electronic eyeglass device 810.

The separate attachment unit 1086 includes electrical/optical components 1030 as described before, such as touch sensors, audio transducers, image projectors, cameras, wireless antennas, and any of the other components described above, which enable the user to have the desired mobile capabilities, without replacing the user's existing eyeglasses 1084. Attachment units 1086 can be attached to one or both side arms and/or optic frames of the existing eyeglasses 1084, or attached via a lanyard.

The various electrical/optical components described above, including the input, output, and infrastructure components such as computer processors, cameras, induction coils, tactile sensors (touch, proximity, force, etc), audio transducers, and others, can be mounted in any suitable way on the eyeglass frame. The components can be housed within a portion of the frame, such as mounted within the side arm. They can be mounted just under a top surface of the frame, such as mounted on the optic frame just under a cover or top layer. They can be covered, laminated, or over-molded with other materials. The electrical/optical components can be printed, etched, or wound onto a substrate that is mounted on the frame, such as the coil 862 being printed on a portion of the side arm 814. The components can be attached to the outer, exposed surface of the frame, such as an image projector or a camera being mounted on the side arm or optic frame, by adhesives, magnets, mechanical fasteners, welding, and other attachment means. Additional components can be connected via a lanyard or can interact with the eyeglass frame via wireless communication.

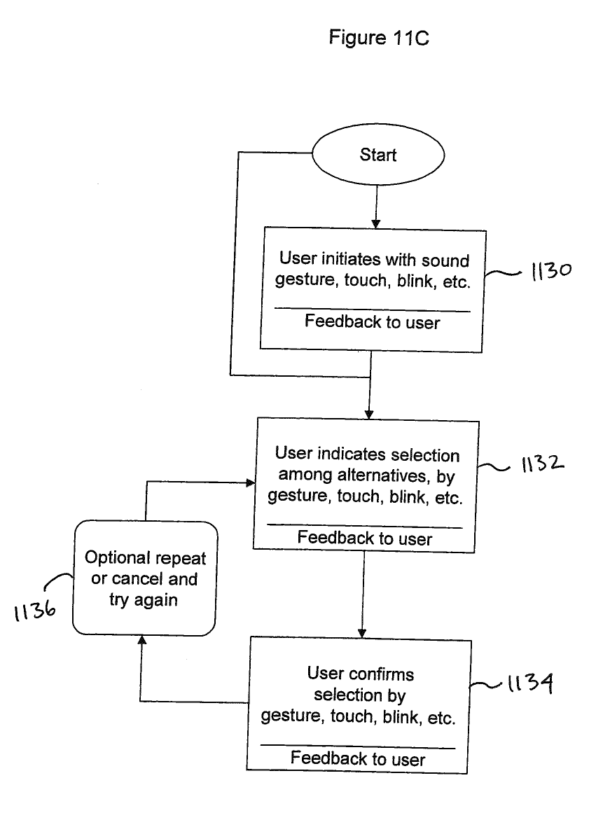

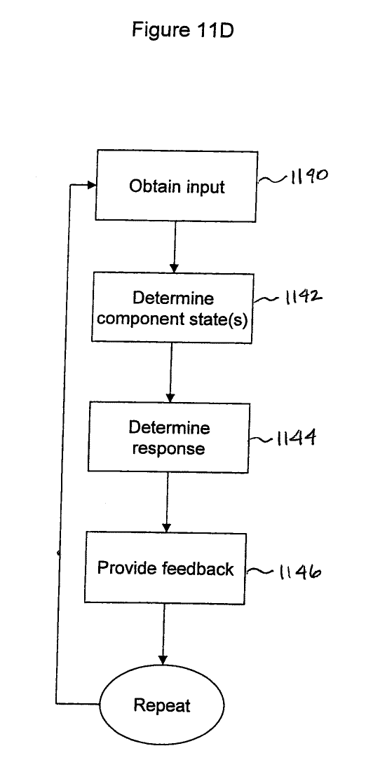

The various electrical/optical components on the eyeglass device are controlled by a control system that is run by an on-board computer processor. The control system is executed by a set of programming instructions stored on the computer, downloaded, or accessed via an attached device. The control system manages the electrical/optical components, processes the inputs, and provides the requested outputs. A flowchart for this control system is shown in FIG. 11A. The control system obtains user input 1102. As explained above, this input can take various forms, such as the user speaking a command, touching a sensor, adjusting a knob, blinking, or many other possible inputs. The control system also obtains and stores the state of the eyeglass device 1104. This means that the control system stores the state of all of the various electrical/optical components and programming, such as whether the camera is recording, or whether the image projector is displaying an email, or whether the web browser is downloading a file.

Next, the control system applies the user interface logic to the user input and the state 1106. The user interface logic is a set of programming instructions stored in memory on the eyeglass device. The user interface logic includes logic, or instructions, for changing the state of the various components in response to input from the user. The user interface logic provides instructions for determining a state of the eyeglass device and determining the desired output in response to the user input and the state. The state can include the state of the output device, the state of the input device, and the state of the processor, that is, the state of the programs running on the processor and the state of the user interface.

In step 1106, the control system applies the set of programming instructions to the inputs it has been given. For example, the state may be that the MP3 player is playing a song, and the input may be that the user slid a finger from back to front along a slider sensor. Given the state of playing the song, and the input on the slider sensor, the user interface logic may instruct the control system that this means the user wants to increase the volume of the audio. The user interface logic is the instructions that translate the inputs (component states and user inputs) into outputs (adjusting settings, providing content, changing a component status).

Next, the control system optionally provides user feedback to confirm the user input 1108. This can be as simple as playing a click sound when the user touches a sensor, so that the user knows that the input was received. Depending on the state and the sensor, a different confirmation might be provided. The confirmations can be, for example, sounds (clicks, chimes, etc) or visual images (an icon displaying or flashing) or even a tactile response such as a brief vibration, to let the user know that the input was received (that the button was successfully pushed or the sensor tapped). As the user is adjusting a setting, a visual display can show the adjustment (such as a visual display of a volume level, as the user slides it up or down). The user interface logic determines whether and how to provide this feedback, based on the component states and user inputs.

The control system also responds to the user input 1110. Based on the input and the state, and applying the user interface logic, the control system determines what response to give to the user. As a few examples, this can include providing content 1112 (such as playing a song, displaying a photograph, downloading email), obtaining content 1114 (obtaining a signal from the GPS receiver, initiating a phone call, etc), operating an electrical/optical component 1116 (turning on a camera, activating an environmental sensor, etc), or changing a setting 1118 (increasing volume, or brightness, or changing a ringtone). The control system repeats these steps as necessary as it receives additional user input.

Another flowchart is shown in FIG. 11B, to show the separate processes for providing feedback to the user (on the left) and rendering content for the user (on the right). As shown on the flowchart on the left, the system obtains user input in step 1120 (such as input from the eye tracker—look angle, blinks, look dwell—or other audible or visual inputs such as gestures, expression, words, etc) and applies the user interface logic interacting with state information in step 1122. According to the user interface logic and the current state of the components, the system then provides user feedback (such as visible, audio, and tactile feedback confirming the input) in step 1124. These steps are repeated with additional user input.

On the right side of FIG. 11B, the flowchart shows the steps for rendering content according for providing to the user. The system selects content from the available sources, responsive to the user interface logic, in step 1126. The user interface logic directs the system to select the appropriate content based on the inputs that have been provided to the user interface logic—the state of the components, and the input from the user. Then, in step 1128, the system renders and controls the content based on the rendering options and user controls. These include brightness settings (for visual content), relative position settings (for visual content, such as whether the image is fixed with respect to the user's head, or to the ground), audio settings, etc. The system applies these options and settings to deliver the selected content to the user in the appropriate format.

Another exemplary control flowchart is shown in FIG. 11C. This flowchart shows the steps that take place when a user wants to adjust a setting, such as a volume level. In this example, in step 1130, the user optionally initiates the process by providing an input to the eyeglass device (such as gesture, touch, blink, audio commands, etc). For example, the user may decide to change the volume of audio that the device is outputting, so the user touches a sensor or speaks a command or tilts his or her head or does another of various options to instruct the device that the user wants to change the volume. The system may provide feedback to the user, such as an audible click or a visible flash, to confirm the input. Alternatively, the eyeglass device may automatically prompt the user to input a volume selection, without the user initiating. For example, the first time the user accesses an on-board MP3 player, the eyeglass device may prompt the user to input a default volume setting.

In step 1132, the user indicates a selection, such as increasing or decreasing volume, by any of various input options (gesture, touch, etc). Again, the system may provide feedback to the user, such as making a clicking sound each time the user adjusts the volume up or down, or displaying a graph of the volume. In step 1134, the user confirms the selection by making another input, such as blinking to indicate that the volume has been adjusted as desired. Again, the system may provide feedback to confirm this input. Optionally, in step 1136, the user may decide to re-adjust the volume (or whatever other input is being given), or to cancel the user's selection and start over. For example, the user may decide he or she made a mistake in the adjustment, and may go back to step 1132 to re-adjust the volume. In each of these steps, the output from the device (the feedback to the user, and the adjustment of the setting) is determined by the user interface logic, which takes the component state (such as current volume level) and the user input (such as pressing a button) and applies the stored programming instructions to determine the output (a click to confirm the pressed button, and an increase in the volume). Volume adjustment is only one example, and this process can be used for adjustment of other controls and settings, or other user inputs.

Another embodiment of an exemplary control system is shown in FIG. 11D. In this embodiment, the control system obtains input in step 1140, such as from the user or from environmental sensors, other sensors, monitors, and/or communications devices. The system then determines component states in step 1142, including which programs or components are running and their status. The system then determines a response in step 1144, based on its programming instructions. The system then provides feedback in step 1146, which can include feedback that confirms the input (a visible icon or audible click, for example), as well as feedback that responds to the input (providing content to the user, turning on or off a device, increasing the volume, for example). The system optionally repeats, with more user input at step 1140.

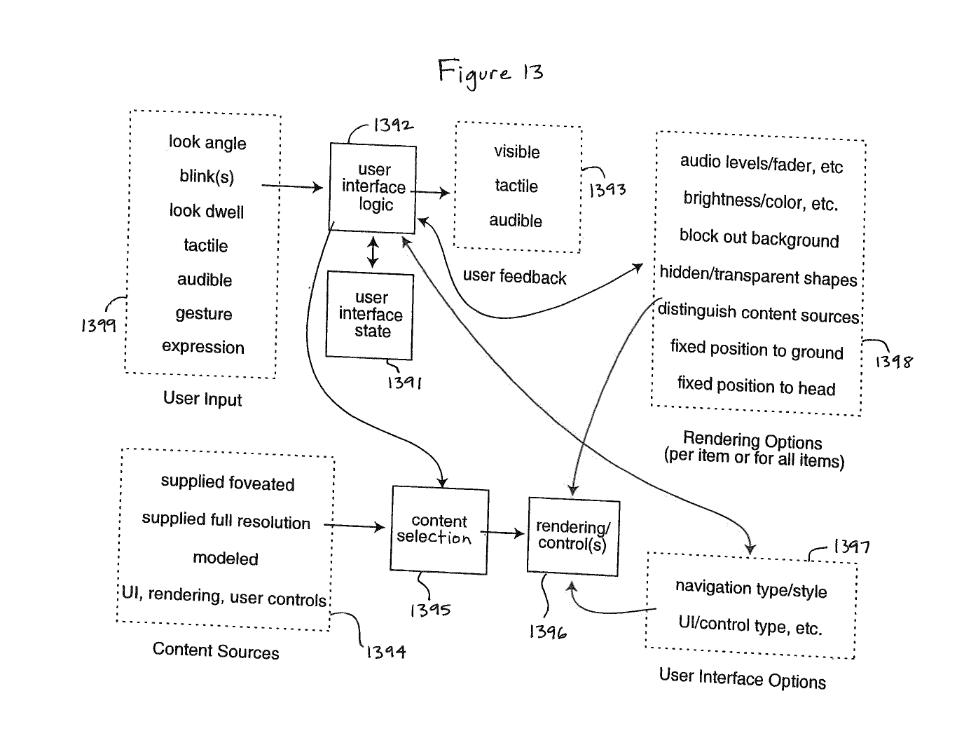

FIG. 13 shows a functional block diagram of a control system according to an embodiment of the invention. The user interface logic 1392 interacts with the user interface state 1391. The user interface logic also receives input from the user input source in box 1399. The user input sources can include look angle, blink(s), look dwell, tactile inputs (touch, proximity, pressure, area, etc), audible inputs, gesture (raising a hand in front of a camera, shaking the head, etc) and expression. Optionally, when the user generates an input, the user interface logic directs the system to provide user feedback to confirm the input, in box 1393, such as by visible, tactile, or audio feedback.

The user interface logic 1392 also directs the system to select content in box 1395, from content sources 1394 (including supplied foveated images, supplied full resolution images, modeled images, user inputs, rendering, and user controls). The content selection 1395 gives direction to the rendering control(s) 1396, which take input from rendering options 1398 and user interface options 1397.

Rendering options 1398 include settings and options that can be applied to a particular input source or a content stream from a source, or the settings can be applied to all of the sources or streams. These options and settings affect how the content is seen, heard, or felt. For example, these rendering options include audio levels/faders (controls for an audio device), brightness/color (controls for an image such as a photograph or video), an option to block out the background (for example, hiding the natural background environment, such as by an LCD shutter, either partly or fully, and in particular parts of the user's field of view or across the entire field of view), an option to have hidden or transparent shapes (for example, to control the transparency of images that are projected, so that they can be seen behind overlapping images or can hide one another), an option to distinguish content sources (for example, allowing the user to blink to identify a content source such as to distinguish a projected image from reality), an option to fix a position with respect to the ground (for example, so that a projected image does not move when the user's head moves) or to fix a position with respect to the head (so that a projected image moves with the user's head, staying at the same angle to the head).

User interface options 1397 are options that affect the user's interaction with the glasses. The user can modify these options from default settings or previous settings. An example is navigation type/style, which can include colors, graphics, sound, styles, and other options related to the way the user interface allows the user to find and select content and to configure itself Another example is user input control types, including settings such as click rates, or enabling touch or clapping, and other low-level settings affecting the way the user interacts with the user interface.

As shown in FIG. 13, the rendering controls 1396 take input from the rendering options 1398, the user interface options 1397, and the content selection 1395 in order to control and provide the requested content to the user in the desired format. The rendering options 1398 and user interface options 1397 communicate back and forth with the user interface logic 1392. The content selection 1395 takes input from the user interface logic 1392 and the content sources 1394.

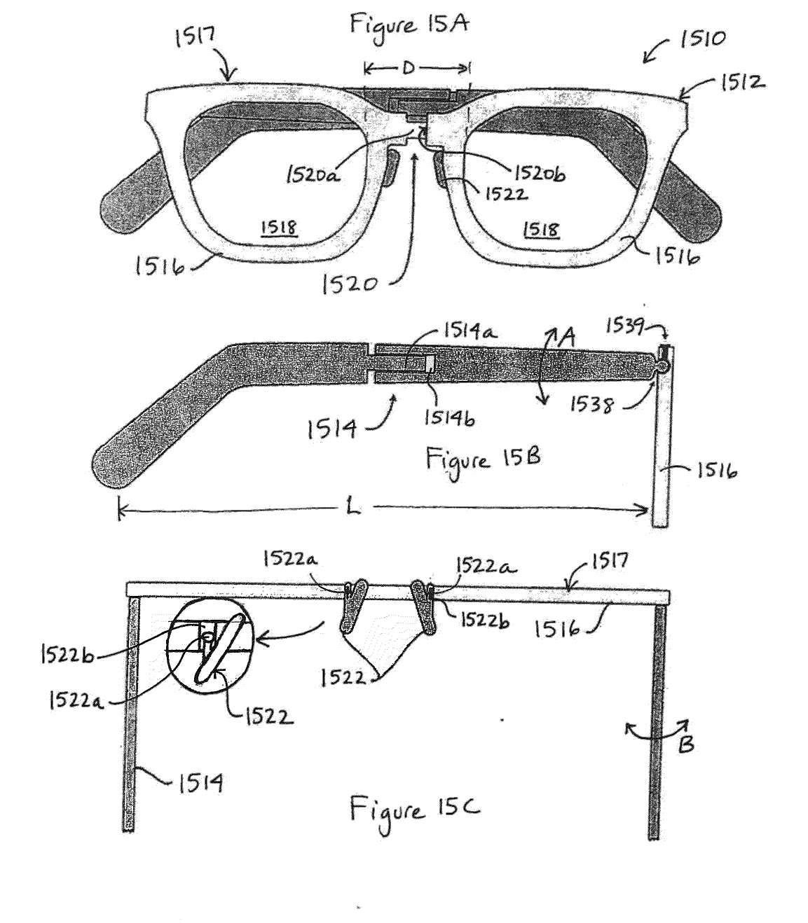

In another embodiment of the invention as shown in FIGS. 15A-C, an eyeglass device 1510 includes an eyeglass frame 1512 that is adjustable with respect to the user's head. Various optional adjustment mechanisms can be provided to adjust the frame 1512 based on the size and position of the user's head, eyes, nose, and ears. For example, in FIG. 15A, the eyeglass frame 1512 includes a telescoping nose bridge 1520. The telescoping nose includes an arm 1520a that is slidably received into a hollow cavity 1520b. The arm 1520a can be slid into and out of the cavity 1520b in order to adjust the length of the nose bridge 1520. This adjustment will change the distance D between the two optic frames 1516, which can be useful to accommodate the width of the user's nose and the distance between the user's eyes. This adjustment enables the wearer to adjust based on his or her inter-pupilary distance (“IPD”), the distance between the pupils of the user's eyes. Depending on the type of optic 1518, it can be important for the 1PD to be adjusted correctly so that the light reflected, refracted, or otherwise redirected by the optic 1518 will be correctly directed into the user's eyes.

As shown in FIG. 15B, the eyeglass frame 1512 optionally includes a telescoping side arm 1514. The telescoping side arm 1514 includes a sliding arm 1514a that slides in and out of a slot 1514b in the side arm, to adjust the length L of the side arm 1514. In one embodiment, both side arms 1514 include this telescoping mechanism, and the side arms can be adjusted independently. This adjustment is useful to accommodate the distance between the user's ears and nose. In another embodiment, the side arm 1514 is adjustable by bending components of the side arm 1514, rather than by sliding or telescoping.

Additionally, as shown in FIG. 15B, the eyeglass frame 512 optionally includes a ball joint 1538 connecting the side arm 1514 to the optic frame 1516. This ball joint 1538 allows the side arm 1514 to rotate with respect to the optic frame 1516. The side arm 1514 can rotate in two planes. First, it can rotate up and down (in the direction of arrow A) with respect to the optic frame 1516, to adjust for the height of the wearer's ears. This adjusts the pitch of the optic frame 1516 up or down with respect to the side anus 1514. Second, the side arm 1514 can rotate side to side (in the direction of arrow B, shown in FIG. 15C), to adjust for the width and angle of the user's head. The side arms 1514 can be rotated as desired about the ball joint 1538, and then secured in place by tightening a pin 1539. The pin 1539 is tightened against the ball joint 1538 to prevent further rotation about the ball joint 1538. The pin 1539 can be unscrewed to allow movement about the ball joint 1538 in order to re-adjust the side arm 1514.

As shown in FIG. 15C, the frame 1512 can optionally include adjustable nose pads 1522. The nose pads can be adjusted in two ways. First, the angle of the nose pads with respect to the optic frames 1516 can be adjusted by rotating the nose pads about pin 1522a. This adjustment can accommodate the angle of the user's nose. Second, the nose pads 1522 can be moved toward and away from the optic frame 1516, to adjust the distance of the optic frame 1516 from the user's face. The pins 1522a can be moved along slots 1522b in order to move the nose pads 1522 toward or away from the optic frame 1516. An enlarged view of the pin 1522a and slot 1522b is shown in the inset to FIG. 15C. The adjustment of the nose pads 1522 can cooperate with the telescoping side arm 1514 to adjust the distance of the optics 1518 from the user's face.

FIGS. 16A shows a portion of eyeglass frame 1612 which allows the optic 1618 to be adjusted with respect to the frame 1612. In this embodiment, the eyeglass frame 1612 includes a clamp 1601 that connects the optic 1618 to the side arm 1614. The clamp 1601 includes an inner clamping member 1602 and an outer clamping member 1603. These two clamping members can be moved toward each other to clamp the optic 1618 between them, by tightening the tightening screw 1604. Tightening this screw 1604 will bring the two clamping members 1602, 1603 closer together, fixing the optic 1618 in place between them, and loosening the screw 1604 will move the clamping members apart, so that the optic 1618 is released.

When the optic 1618 is released, it can be moved up and down or side to side within the slot 1605 between the two clamping members. That is, the optic 1618 can be adjusted side to side in the direction of arrow C, and can be moved up and down (perpendicular to the plane of the paper). The slot 1605 allows this movement in two planes. When the optic is in the desired position, the screw 1604 is tightened to fix it in place. This adjustment allows the optic 1618 to be raised up or down with respect to the frame 1612, to accommodate the height of the user's eyes, as well as side to side, to accommodate the user's IPD. Although only one clamp 1601 and one optic 1618 are shown in FIG. 16, both optics on the eyeglass frame can be mounted with a clamp to allow for this adjustment.

The optic 1618 can also be adjusted along the side arm 1614 to adjust the distance between the optic 1618 and the user's face. This is accomplished by moving the second tightening screw 1606 within slot 1607. This slot 1607 allows the optic 1618 to be toward and away from the user's face, in the direction of arrow D.

The adjustments along slots 1605 and 1607 allow the optic 1618 to be adjusted in three dimensions (x—direction C, y—perpendicular to the page, and z—direction D), to position the optic 1618 in the desired location for the individual user. This type of adjustment is useful when the optic 1618 is designed to have a particular point behind the optic that needs to be at the center of rotation of the user's eye. As described in more detail in the co-pending applications already incorporated by reference, certain optics have a point a certain distance behind the optic that should be located at the center of rotation of the user's eye, in order for the optic and its associated image systems to function appropriately. The location of this point will depend on the particular optic being used. The clamp 1601 just described enables the optic 1618 to be adjusted to move this point to the center of rotation of the user's eye, based on the unique characteristics of the individual user. In this embodiment, the eyeglasses need not be specifically manufactured and dimensioned for a particular user, based on that user's facial features; instead, the eyeglasses can be adjusted for each individual user.

Adjustment for the individual user, to place the point behind the optic on the center of rotation of the eye (when such an optic is used), can be accomplished with the x, y, and z adjustments provided by the clamp 1601. In one embodiment, the second screw fastener 1606 clamps the optic 1618 with only moderate force, so as not to overconstrain or stress the optic.

Optionally, the clamp 1601 includes a flexible or deformable material (not shown for clarity), to protect the clamped optic 1618 from vibrations from the frame 1612.

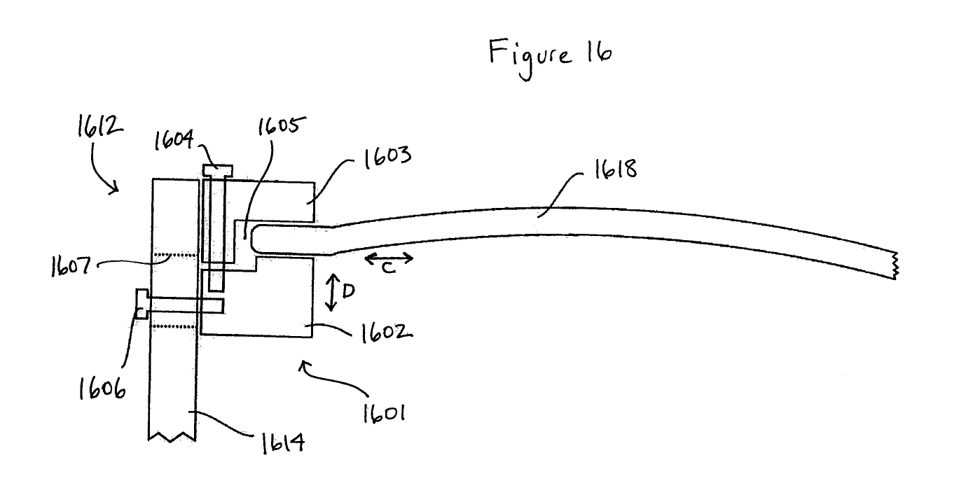

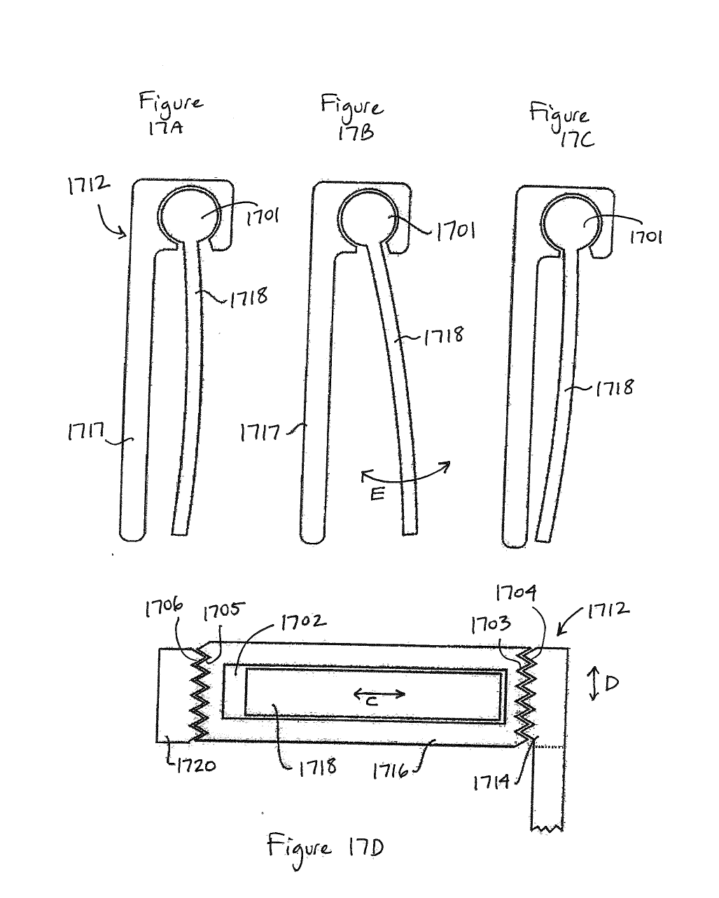

Another embodiment of an adjustable eyeglass frame 1712 is shown in FIGS. 17A-D. As shown in the side views of FIGS. 17A-C, the frame 1712 includes a front face 1717 and an adjustable optic 1718. The optic 1718 pivots about a rod 1701 at the top of the front face 1717. This rod 1701 enables the optic 1718 to rotate forward and backward with respect to the front face 1717, toward and away from the user's face, in the direction of arrow E. In FIG. 17B, the optic 1718 has been rotated outward, away from the user's face, and in FIG. 17C it has been rotated inwardly, toward the user's face. This adjustment changes the pitch of the optic 1718, the angle of the optic with respect to the user's face. While a rod 1701 is shown, other types of mounts or joints such as a ball joint or pins can be used to rotatably mount the optic 1718 to the frame 1712.

The optic 1718 can also be adjusted in the “x” direction, in the direction of arrow C, as shown in FIG. 17D. This adjustment is accomplished by sliding the optic 1718 within the slot 1702. This adjustment can be made to accommodate the user's IPD.

Finally, also shown in FIG. 17D, the optic 1718 can be adjusted in the “z” direction, in the direction of arrow D, toward and away from the user's face. This adjustment is accomplished by the mating edges 1703, 1704 on the optic frame 1716 and the side arm 1714, respectively, and the mating edges 1705, 1706 on the optic frame 1716 and nose bridge 1720, respectively. In the embodiment shown, these edges 1703-1706 are formed as teeth or triangular edges that mate together in alternating recesses. In other embodiments these edges can be other types of mating surfaces, such as dovetails or mating groove components. The entire optic frame 1716 can be slid out, vertically, from the side arm 1714 and nose bridge 1720, then moved in the direction of arrow D, and then slid back into place between the side arm 1714 and nose bridge 1720. This allows the distance between the optic 1718 and the user's face to be adjusted, in the “z” direction. This type of mating groove or mating teeth connection can also be used at other locations on the frame 1712 to provide for adjustability.

Thus, the adjustable frame 1712 shown in FIGS. 17A-D can be adjusted in pitch (as shown in FIGS. 17A-C), “x” direction (arrow C), and “z” direction (arrow D).

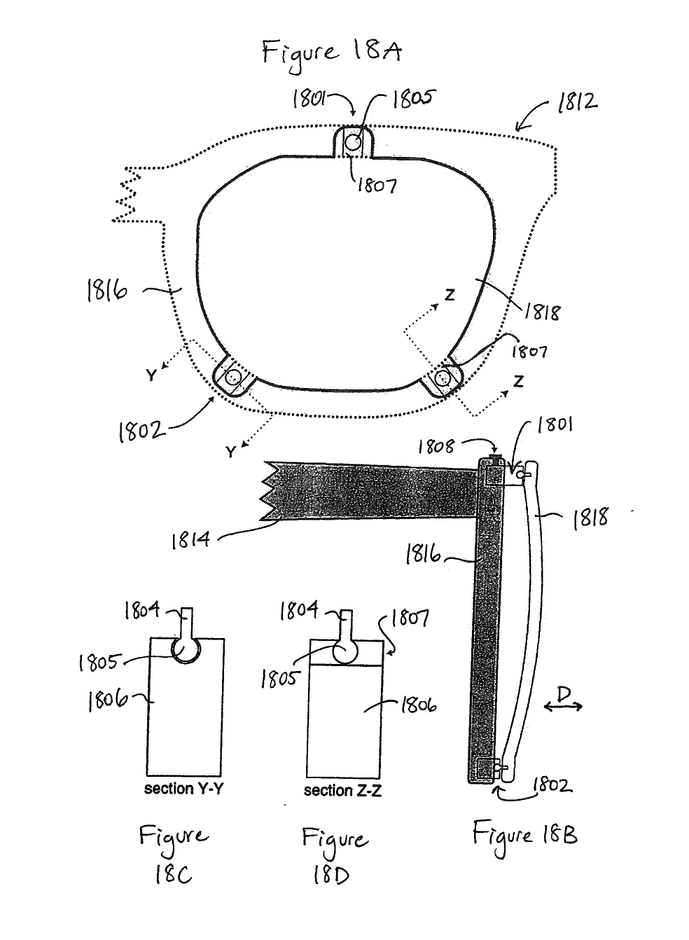

Another embodiment of an adjustable frame is shown in FIGS. 18A-D. As shown in FIG. 18A, an eyeglass frame 1812 includes three adjustable mounts 1801, 1802, 1803. The optic 1818 is attached to the optic frame 1816 by these three mounts 1801, 1802, 1803. Each mount 1801, 1802, 1803 includes a stud 1806 that supports a post 1804 with an enlarged end 1805. The post 1804 connects to the optic 1818, as shown in FIG. 18B. The enlarged end 1805 of the post 1804 is slidable within a slot 1807 at the top of the stud 1806.

The three mounts 1801, 1802, 1803 allow the tilt of the optic 1818 to be tilted in two planes. The stud 1806 of each mount can be screwed into or out of the optic frame 1816 to adjust the distance that it extends out from the frame 1816. By adjusting the relative distances of the three studs, the tilt of the optic 1818 can be adjusted. As shown in FIG. 18B, the stud of mount 1801 has been extended out from the frame 1816 farther than mount 1802. By unscrewing the stud 1806 of mount 1801, the stud 1806 moves out away from the frame 1816, as shown in FIG. 18B. The stud of mount 1802 can be screwed into the frame, to move the stud closer to the frame 1816. This effectively tilts the optic 1818 to point more downwardly. The three mounts 1801, 1802, 1803 can be adjusted individually to tilt the optic 1818 up or down, or side to side. The mounts enable adjustment of pitch (the optic 1818 tilting up and down with respect to the frame 1816) and yaw (the optic tilting side to side with respect to the frame).

The three mounts also enable the optic 1818 to be moved closer or farther to the frame 1816, by moving all three studs into or out of the frame This enables adjustment of the distance between the optic 1818 and the user's face—adjustment in the “z” direction, in the direction of arrow D.

When the mounts are individually adjusted, the enlarged end 1805 of the post 1804 will slide within the slot 1807 to adjust as necessary in order to avoid bending or flexing the optic 1818. Cross-sectional views of the enlarged end 1805 are shown in FIG. 18C, taken across the slot 1807, and FIG. 18D, taken along the slot 1807. The slots allow the optic to adjust so that it does not become overconstrained by the mounts.

Optionally, the frame 1812 includes a locking pin 1808 that can be tightened against one of the mounts, such as mount 1801, to lock the optic 1818 into place after the mounts have been adjusted as desired. By tightening the locking pin 1808, the stud 1806 of mount 1801 can no longer be adjusted until the locking pin is released.

In other embodiments, the post 1804 may be movable with respect to the optic 1818, in which case the stud 1806 may or may not be movable with respect to the frame 1816. The stud and post can be reversed, with the stud moving within a slot on the optic, and the post being connected to the frame. In another embodiment, two of the mounts are adjustable, but the third mount is fixed, in which case the post and stud may be made as one piece and may be integrally formed with the frame.

The optic 1818 can be adjusted in pitch, yaw, and the “z” direction. As described earlier, the adjustment mechanism of the frame 1712 (shown in FIGS. 17A-D) can be adjusted in pitch, “x”, and “z” directions. The adjustment mechanism of frame 1612 (shown in FIG. 16) can be adjusted in “x”, “y”, and “z” directions. Each of these embodiments allows the respective optic to be adjusted in order to place a particular point behind the optic on a particular point with respect to the user's eye, such as on the center of rotation of the user's eye. In order to move this point to a position on the eye, the optic is adjusted in the “z” direction (toward and away from the user's face, direction D), and in either the “x” direction (horizontal translation, side to side, direction C) or yaw, and in either the “y” direction (vertical translation, up and down) or pitch. In other embodiments, other mechanisms for making these adjustments can be used, such as ball joints, screw fasteners, slots, telescoping members, bendable members, mating grooves, and other connectors that allow adjustment in various degrees of freedom, in order to adjust the optic with respect to the frame, to accommodate each individual user.

Although the present invention has been described and illustrated in respect to exemplary embodiments, it is to be understood that it is not to be so limited, since changes and modifications may be made therein which are within the full intended scope of this invention as hereinafter claimed. For example, many different combinations of electrical/optical components can be provided on an eyeglass frame to create many different applications, and the examples described herein are not meant to be limiting.

What is claimed is:

1. A multimedia eyeglass device, comprising:
an eyeglass frame, comprising a side arm and an optic frame;
an output device for delivering an output to the wearer, the output device being supported by the eyeglass frame and being selected from the group consisting of a speaker, a bone conduction transmitter, an image projector, and a tactile actuator;
an input device for obtaining an input, the input device being supported by the eyeglass frame and being selected from the group consisting of an audio sensor, a tactile sensor, a bone conduction sensor, an image sensor, a body sensor, an environmental sensor, a global positioning system receiver, and an eye tracker; and
a processor comprising a set of programming instructions for controlling the input device and the output device.

2. The device of claim 1, wherein the processor applies a user interface logic that determines a state of the eyeglass device and determines the output in response to the input and the state.

3. The device of claim 2, wherein the state comprises a state of the output device, a state of the input device, and a state of the processor.

4. The device of claim 1 or 2, wherein the input device comprises a tactile sensor.

5. The device of claim 4, wherein the tactile sensor comprises a touch sensor.

6. The device of claim 1 or 2, wherein the output device comprises a bone conduction transmitter.

7. The device of claim 1 or 2, wherein the input device comprises a bone conduction sensor.

8. The device of claim 1 or 2, wherein the eyeglass frame is adjustable.

9. The device of claim 8, further comprising an optic supported by the optic frame, and wherein the optic is adjustable with respect to the eyeglass frame.

10. The device of claim 9, wherein the optic is connected to the side arm by a clamp, and wherein the optic is translatable horizontally and vertically within the clamp.

11. The device of claim 1, wherein the input device comprises a microphone.

12. The device of claim 1, wherein the input device comprises a tactile sensor, and wherein the tactile sensor is selected from the group consisting of a touch sensor, a proximity sensor, a temperature sensor, a pressure sensor, and a strain gage.

13. The device of claim 12, wherein the tactile sensor comprises a touch sensor or a strain gage mounted on the side arm.

14. The device of claim 12, wherein the tactile sensor comprises a proximity sensor mounted on the optic frame.

15. The device of claim 12, further comprising a plurality of tactile sensors mounted on the side arm.

16. The device of claim 1, wherein the input device comprises a bone conduction sensor.

17. The device of claim 16, wherein the bone conduction sensor is positioned on the eyeglass frame to contact the user's nose.

18. The device of claim 17, wherein the eyeglass frame comprises a nose pad, and wherein the bone conduction sensor is supported by the nose pad.

19. The device of claim 16 or 18, further comprising a microphone, wherein an input signal from the microphone is combined with an input signal from the bone conduction sensor to produce a combined audio signal.

20. The device of claim 16, wherein the processor comprises a digital signal processor configured to digitally process a signal from the bone conduction sensor.

21. The device of claim 1, wherein the input device comprises an eye tracker configured to sense one of eye position, eye movement, dwell, blink, and pupil dilation.

22. The device of claim 1, wherein the input device comprises a camera.

23. The device of claim 22, wherein the camera is mounted on the optic frame.

24. The device of claim 1, wherein the input device comprises a body sensor selected from the group consisting of a heart rate monitor, a temperature sensor, a pedometer, and a blood pressure monitor.

25. The device of claim 1, wherein the input device comprises an environmental sensor selected from the group consisting of a temperature sensor, a humidity sensor, a pressure sensor, and an ambient light sensor.

26. The device of claim 1, wherein the input device comprises a global positioning system receiver.

27. The device of claim 1, wherein the output device comprises a speaker.

28. The device of claim 27, wherein the side arm comprises an ear hook, and wherein the speaker is mounted on the ear hook.

29. The device of claim 1, wherein the output device comprises a tactile actuator, and wherein the tactile actuator is selected from the group consisting of a temperature transducer and a vibration transducer.

30. The device of claim 1, wherein the output device comprises a bone conduction transmitter.

31. The device of claim 30, wherein the processor comprises a digital signal processor configured to digitally process a signal and transmit the signal to the bone conduction transmitter.

32. The device of claim 31, further comprising a speaker, and wherein a second signal from the digital signal processor is transmitted to the speaker.

33. The device of claim 1, wherein the eyeglass frame further comprises a nose pad, and wherein a transducer is supported by the nose pad.

34. The device of claim 33, wherein the electrical component supported by the nose pad is a bone conduction device,

35. The device of claim 1, further comprising an optic supported by the optic frame, and wherein the output device comprises an image projector.

36. The device of claim 35, wherein the projector is mounted on the side arm and is positioned to transmit light toward the optic.

37. The device of claim 35, wherein the image projector comprises an illuminator and a lens, the lens being configured to transmit light from the illuminator to the optic.

38. The device of claim 1, wherein the processor comprises protected program memory.

39. The device of claim 1, further comprising an antenna.

40. The device of claim 1, further comprising a communication port for coupling the device with an external system.

41. The device of claim 40, wherein the communication port is a USB port.

42. The device of claim 1, further comprising a switch connected between the side arm and the optic frame.

43. The device of claim 1, further comprising a hinge connecting the side arm and the optic frame, and wherein the hinge comprises one of a slip ring or a switch.

44. The device of claim 1, further comprising an induction coil located on the eyeglass frame.

45. The device of claim 1, further comprising a lanyard connected to a package comprising an electrical component.

46. The device of claim 45, further comprising a power source, and wherein the electrical component is electrically coupled to the power source.

47. The device of claim 1, wherein the side arm is detachable from the eyeglass frame, and further comprising a replacement side arm attachable to the eyeglass frame.

48. The device of claim 1, wherein the output device, the input device, the processor, and the power source are housed in an attachment unit that is mounted on the side arm.

49. The device of claim 1, wherein the eyeglass frame is adjustable.

50. The device of claim 49, wherein the side arm has a telescoping portion.

51. The device of claim 49, wherein the eyeglass frame comprises a telescoping nose bridge.

52. The device of claim 49, wherein the side arm is connected to the optic frame by a ball joint.

53. The device of claim 49, wherein the eyeglass frame comprises a nose pad rotatably and slidably mounted on the optic frame.

54. The device of claim 1, further comprising an optic supported by the optic frame, and wherein the optic is adjustable with respect to the eyeglass frame.

55. The device of claim 54, wherein the optic is adjustable in one of pitch or vertical translation, and one of yaw or horizontal translation, and is adjustable toward or away from the wearer's face.

56. The device of claim 54, wherein the optic is connected to the side arm by a clamp, and wherein the optic is translatable horizontally and vertically within the clamp and clamped when so translated.

57. The device of claim 56, wherein the clamp is connected to the side arm by a tightening pin extending through a slot, and wherein the clamp is slidable along the slot to move the optic toward or away from the user.

58. The device of claim 54, wherein the optic frame and the side arm comprise mating grooves, and wherein the optic frame is movable toward and away from the user's face by adjusting the relative position of the grooves.

59. The device of claim 54, wherein the optic is coupled to the optic frame by a rod, and wherein the optic is rotatable about the rod to pitch with respect to the optic frame.

60. The device of claim 54, wherein the optic is mounted to the optic frame by first, second, and third mounts, and wherein at least the first and second mounts are adjustable with respect to the optic frame to move the optic toward or away from the optical frame.

61. The device of claim 60, wherein each mount comprises a stud that is movable toward and away from the optic frame, and a post connecting the optic to the stud.

62. The device of claim 1, wherein the user interface state is changeable by an input from the input device.

63. The device of claim 1, further comprising a power source electrically or optically coupled to the output device, the input device, and the processor.

64. A head-worn multimedia device comprising:
a frame comprising a side arm and an optic frame;
an audio transducer supported by the frame;
a tactile sensor supported by the frame;
a processor comprising a set of programming instructions for receiving and transmitting information via the audio transducer and the tactile sensor;
a memory device for storing such information and instructions; and
a power supply electrically coupled to the audio transducer, the tactile sensor, the processor, and the memory device.

65. A method for controlling a multimedia eyeglass device, comprising:
providing an eyeglass device comprising:
an output device for delivering information to the wearer, the output device being selected from the group consisting of a speaker, a bone conduction transmitter, an image projector, and a tactile actuator;
an input device for obtaining information, the input device being selected from the group consisting of an audio sensor, a tactile sensor, a bone conduction sensor, an image sensor, a body sensor, an environmental sensor, a global positioning system receiver, and an eye tracker; and
a processor comprising a set of programming instructions for controlling the input device and the output device; and
providing an input by the input device;
determining a state of the output device, the input device, and the processor;
accessing the programming instructions to select a response based on the input and the state; and
providing the response by the output device.

66. The method of claim 65, wherein the programming instructions comprise a user interface logic for determining the response based on the input and the state.

67. The method of claim 66, wherein the user interface logic comprises logic for changing the state responsive to the input.
